(19) United States
(12) Patent Application Publication
(10) Pub. No.: US 2017/0105131 A1
(43) Pub. Date: Apr. 13, 2017

(54) ELECTRONIC DEVICE AND METHOD FOR IMPLEMENTING SERVICE THEREOF

(71) Applicant: Samsung Electronics Co., Ltd., Gyeonggi-do (KR)

(72) Inventors: Gajin SONG, Gyeonggi-do (KR); Jaebong Chun, Gyeonggi-do (KR); Gyucheol Choi, Gyeonggi-do (KR); Myunggon Hong, Gyeonggi-do (KR)

(73) Assignee: Samsung Electronics Co., Ltd.

(21) Appl. No.: 15/290,500

(22) Filed: Oct. 11, 2016

(30) Foreign Application Priority Data
Oct. 8, 2015 (KR) 10-2015-0141757

(51) Int. Cl. H04W 24/04; H04W 4/00

(52) U.S. Cl. CPC H04W 24/04; H04W 4/008; H04W 4/005; H04W 88/16

(57) ABSTRACT

An electronic device is provided. The electronic device includes a communication module, a memory configured to store resource information of a plurality of external devices including a first external device and a second external device that are connected through at least one short-range wireless communication, and a processor that is configured to sense an abnormal state related to the first external device, select the second external device as a backup device when the abnormal state of the first external device is sensed based on at least the resource information, and transmit a request for supplementing a function of the first external device related to the abnormal state to the second external device using the communication module.

### PRIORITY

This application claims priority under 35 U.S.C. §119(a) to Korean Patent Application Serial No. 10-2015-0141757, which was filed on Oct. 8, 2015, in the Korean Intellectual Property Office, the entire disclosure of which is incorporated herein by reference.

### BACKGROUND

1. Field of the Disclosure

The present disclosure relates generally to an electronic device that implements a service using short-range wireless communication and a method for implementing a service thereof, and more particularly, to an electronic device that can supplement an external device (e.g., hub or gateway) when an abnormal state of the external device is sensed.

2. Description of the Related Art

The Internet of Things (IoT) may be configured to include, for example, an electronic device (e.g., smart phone), a home gateway for connecting and controlling different kinds of devices, a server, and IoT devices (e.g., products, such as lamp, refrigerator, and television (TV) to be controlled by the IoT.

Through the IoT, an electronic device can monitor the operating states of IoT devices and can control the corresponding IoT devices.

In the case where IoT devices support a communication type that cannot be directly connected to a server, such as z-wave or ZigBee, the IoT devices may transmit information related to the corresponding IoT devices to the server through an external device (e.g., a gateway), such as hub. For example, the gateway may serve to mediate between the IoT devices and a terminal that controls the corresponding IoT devices in association with an IoT service.

If a gateway that takes charge of such mediation is out of order or an abnormal state occurs between the gateway and the server, the IoT service may not be continuously provided although other devices operate normally.

### SUMMARY

An aspect of the present disclosure provides a method and an apparatus for determining a device that can supplement an external device (e.g., hub or gateway) when an abnormal state of the external device is sensed, and a non-transitory computer readable recording medium.

Another aspect of the present disclosure provides a method and an apparatus for supplementing an external device in a device that supplements the external device, and a non-transitory computer readable recording medium.

In accordance with an aspect of the present disclosure, there is provided an electronic device. The electronic device includes a communication module, a memory configured to store resource information of a plurality of external devices including a first external device and a second external device that are connected through at least one short-range wireless communication, and a processor that is configured to sense an abnormal state related to the first external device, select the second external device as a backup device when the abnormal state of the first external device is sensed based on at least the resource information, and transmit a request for supplementing a function of the first external device related to the abnormal state to the second external device using the communication module.

In accordance with an aspect of the present disclosure, there is provided an electronic device. The electronic device includes a communication module and a processor that is configured to receive a request for performing a backup function for another electronic device of which an abnormal state is sensed among a plurality of external devices, which are connected through at least one short-range wireless communication, from one of the another electronic device and an external electronic device using the communication module, to receive one of resource information and authority information from one of the another electronic device and the external electronic device using the communication module based on the reception of one of the resource information and authority information, and to perform a function related to the abnormal state of the another electronic device based on at least one of the resource information and the authority information.

In accordance with an aspect of the present disclosure, there is provided a method for implementing a service of an electronic device including a memory configured to store resource information of a plurality of external devices including a first external device and a second external device that are connected through at least one short-range wireless communication, a communication module, and a processor. The method includes sensing an abnormal state related to the first external device, selecting the second external device as a backup device when the abnormal state of the first external device is sensed based on at least the resource information using the processor, and transmitting a request for supplementing a function of the first external device related to the abnormal state to the second external device using the communication module.

In accordance with an aspect of the present disclosure, there is provided a method for implementing a service of an electronic device including a memory, a communication module, and a processor. The method includes receiving a request for performing a backup function for another electronic device of which an abnormal state is sensed among a plurality of external devices including the electronic device, which are connected through at least one short-range wireless communication, from one of the another electronic device and an external electronic device, receiving one of resource information and authority information from one of the another electronic device and the external electronic device using the communication module based on at least the reception of one of the resource information and authority information, and performing a function related to the abnormal state of the another electronic device based on at least one of the resource information and the authority information.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a block diagram illustrating an electronic device in a network environment, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 is a block diagram illustrating devices that implement an IoT service, according to an embodiment of the present disclosure;

FIG. 5 is a flowchart of a method for an electronic device or a server to implement an IoT service, according to an embodiment of the present disclosure;

FIG. 6 is a flowchart of a method for an electronic device or a server to implement an IoT service, according to an embodiment of the present disclosure;

FIG. 7 is a flowchart of a method for an electronic device to implement an IoT service as an abnormal state of an external device (e.g., gateway) is sensed, according to an embodiment of the present disclosure;

FIGS. 8A and 8B are diagrams illustrating screens on which an electronic device operates in a gateway mode as an abnormal state of an external device (e.g., gateway) is sensed, according to an embodiment of the present disclosure;

FIGS. 8C and 8D are diagrams illustrating an operation for an electronic device to control an external device (e.g., IoT device) through function switching execution, according to an embodiment of the present disclosure;

FIG. 9 is a flowchart of a method for an electronic device to implement an IoT service as an abnormal state between an external device (e.g., gateway) and a server is sensed, according to an embodiment of the present disclosure;

FIG. 10A is a flowchart of a method for an electronic device to implement an IoT service when a network abnormal state between an external device (e.g., gateway) and a server is sensed, according to an embodiment of the present disclosure;

FIG. 10B is a flowchart of a method for an electronic device to implement an IoT service depending on whether a gateway stands alone, according to an embodiment of the present disclosure;

FIGS. 11A to 11D are diagrams illustrating operations for changing setting information of a priority profile, according to an embodiment of the present disclosure;

FIGS. 12A to 12E are diagrams illustrating IoT device information corresponding to the kind of priority devices, according to an embodiment of the present disclosure;

FIGS. 13A to 13C are diagrams illustrating operations for changing setting information of a priority profile, according to an embodiment of the present disclosure;

FIGS. 14A to 14C are diagrams illustrating operations for changing setting information of a priority profile, according to an embodiment of the present disclosure;

FIGS. 15A to 15D are diagrams illustrating log information of an external device (e.g., IoT device), communication type information, a device profile, and a priority profile, according to an embodiment of the present disclosure;

FIG. 16 is a flowchart of a method for an electronic device to share a gateway function with another electronic device, according to an embodiment of the present disclosure;

FIGS. 17A to 17C are diagrams illustrating an operation for an electronic device to share a gateway function with another electronic device, according to an embodiment of the present disclosure;

FIGS. 18A to 18C are diagrams illustrating an operation for an electronic device to set a gateway function with other electronic devices, according to an embodiment of the present disclosure;

FIG. 19 is a flowchart of a method for an electronic device to request another electronic device to operate in a gateway mode, according to an embodiment of the present disclosure;

FIGS. 20A to 20C are diagrams illustrating an operation for an electronic device to request another electronic device to operate in a gateway mode, according to an embodiment of the present disclosure; and

FIG. 21 is a diagram illustrating security policy information of an external device (e.g., IoT device), according to an embodiment of the present disclosure.

### DETAILED DESCRIPTION

The term “IoT service” as used herein is defined as an environment of the Internet of things, and may be a network environment in which IoT devices can be controlled through a network connection among, for example, an electronic device, a first external device (e.g., gateway), a server, and a second external device (e.g., IoT devices). For example, the IoT service may include an operation to control at least one of the IoT devices or to monitor a state of at least one of the IoT devices through at least one of the electronic device, the gateway, and the server. Further, the IoT service as used herein may be defined as a state where various configurations disclosed in the following drawings are connected through a network to share information.

The term “gateway mode” as used herein is defined as an operation for the electronic device (e.g., a processor) to control respective configurations of the electronic device to supplement the function of the gateway. The gateway mode is not limited to changing of a specific state of the system of the electronic device, but may be an expression that is functionally discriminated to indicate various operations for the electronic device that is controlled by the processor to perform the function of the gateway.

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

Terms “have,” “may have,” “include,” and “may include” as used herein indicate the presence of corresponding features (for example, elements such as numerical values, functions, operations, or parts), and do not preclude the presence of additional features.

Terms “A or B,” “at least one of A or/and B,” or “one or more of A or/and B” as used herein include all possible combinations of items enumerated with them. For example, “A or B,” “at least one of A and B,” or “at least one of A or B” indicates (1) at least one A, (2) at least one B, or (3) both at least one A and at least one B.

Terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present disclosure, and similarly, a second element may be referred to as a first element.

When an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may indicate a dedicated processor (e.g., an embedded processor) for performing a corresponding operation, or a generic-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. A “module” may be a minimum unit of an integrated component or a part thereof. A “module” may be a minimum unit performing one or more functions or a part thereof. A “module” may be mechanically or electronically implemented. For example, a “module” may include at least one of an application-specific integrated circuit (ASIC) chip, field-programmable gate arrays (FPGAs), or a programmable-logic device, which is well known or will be developed in the future, for performing certain operations.

Terms used in describing the various embodiments of the present disclosure are for the purpose of describing particular embodiments and are not intended to limit the present disclosure.

As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

Electronic devices according to the embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. For example, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, TVs, digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or IoT devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices, and may include new electronic devices according to the development of new technologies.

The electronic device may be one of the IoT devices, which may include a device of the IoT. For example, the IoT devices may be various sensors (e.g., gas sensor, door lock sensor, heartbeat sensor, and life-support related sensor), charged couple TV (CCTV) cameras, home robots, refrigerators connectable to the Internet, water purifiers, home appliances such as TV, medical devices, furniture, or parts of a building/structure. The electronic device or the gateway may receive information in a specific environment from the IoT devices, transmit the received information to a cloud or the server, and perform various functions through reception of a feedback from the cloud or the server.

Herein, the term “user” may refer to a person who uses an electronic device or may refer to a device (e.g., an artificial intelligence electronic device) which uses an electronic device.

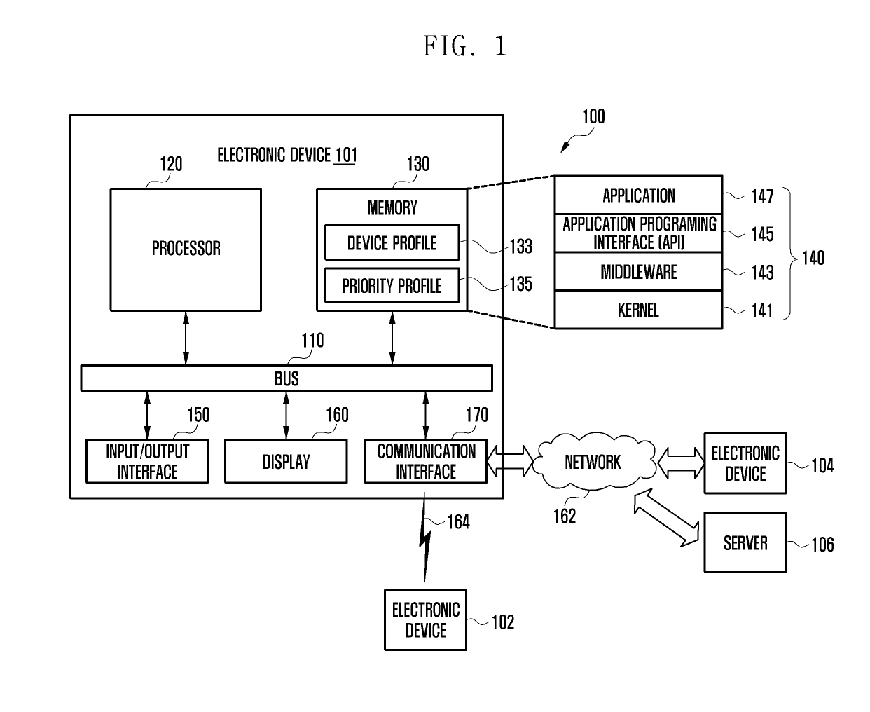

Referring to FIG. 1, an electronic device 101, in a network environment 100, includes a bus 110, a processor 120, a memory 130, an input/output interface 150, a display 160, and a communication interface 170. The electronic device 101 may omit at least one of the components or further include another component.

The bus 110 may be a circuit connecting the above described components and transmitting communication (e.g., a control message) between the above described components.

The processor 120 may include one or more of central processing unit (CPU), application processor (AP) or communication processor (CP). For example, the processor 120 may control at least one component of the electronic device 101 and/or execute calculation relating to communication or data processing.

The memory 130 may include volatile and/or non-volatile memory. For example, the memory 130 may store command or data relating to at least one component of the electronic device 101. The memory may store software and/or program 140. For example, the program 140 may include a kernel 141, middleware 143, an application programming interface (API) 145, and/or an application 147 and so on. At least one portion of the kernel 141, the middleware 143 and the API 145 may be defined as operating system (OS).

The memory 130 may include resource information (e.g., device profile 133) and priority information (e.g., priority profile 135).

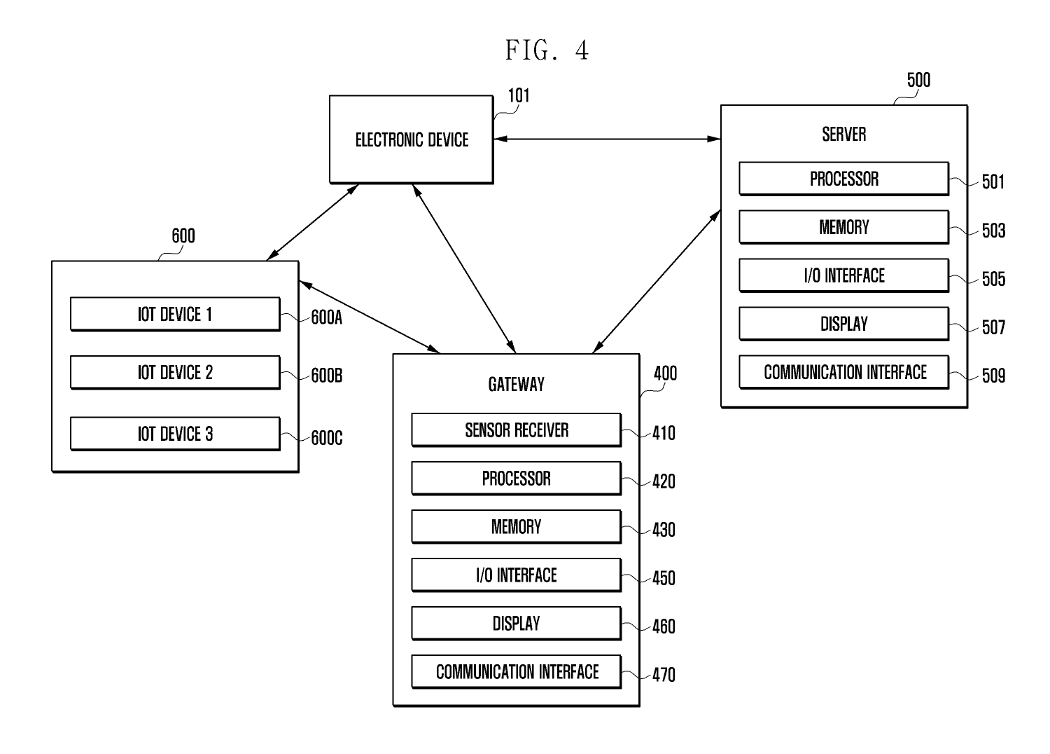

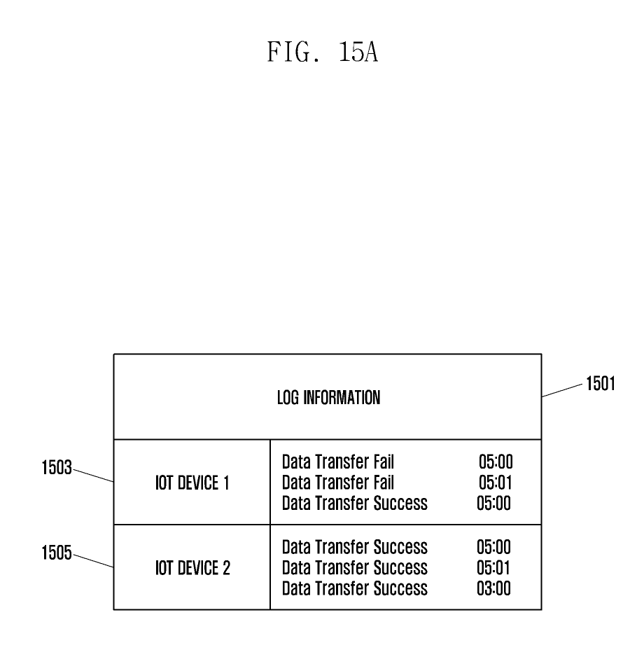

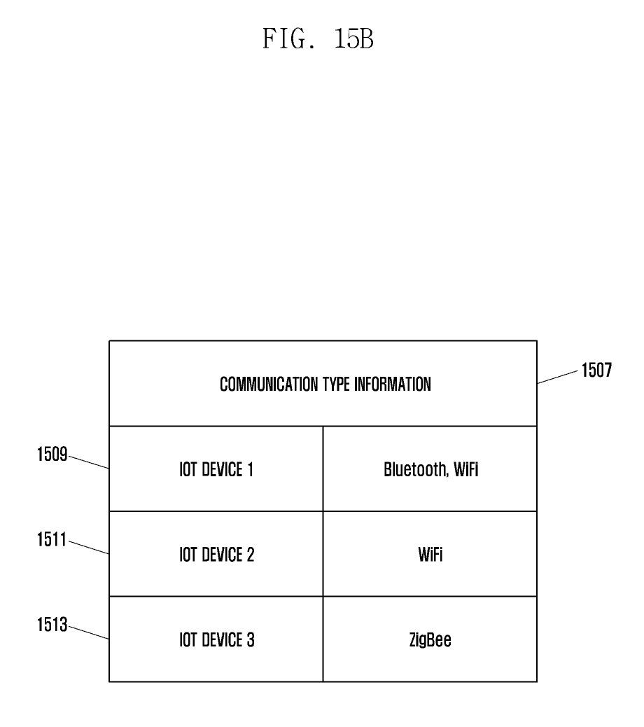

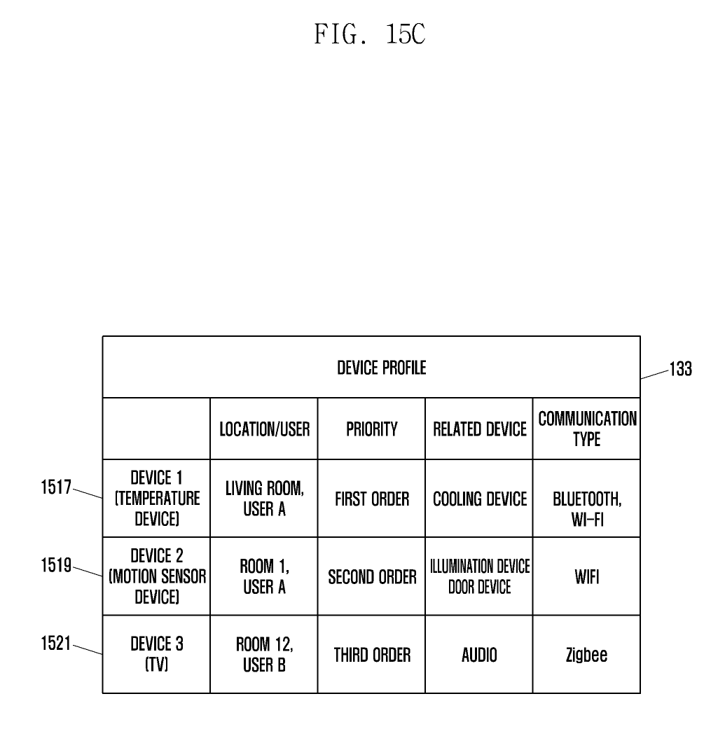

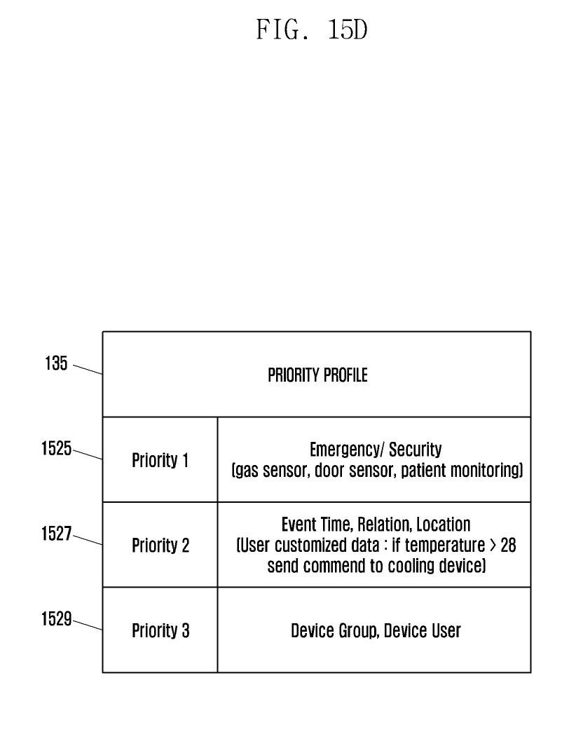

The device profile 133 may include at least one of a device identifier related to IoT devices (e.g., IoT devices 600 (FIG. 4) and/or a first IoT device 1517, a second IoT device 1519, and a third IoT device 1521 (FIG. 15C)), respective location/user information, priority information, related device information, and communication type information. Further, the device profile 133 may further include log information (e.g., log information 1501 (FIG. 15A)), event time, and device power information.

The event time of the device may be information related to an event that is set in the IoT device. For example, if an air conditioner is set to be turned on at three thirty, the three thirty may be defined as an event time for the air conditioner. The device power information may be information related to power of the IoT device. For example, the device power information may be information related to a connection state between the IoT device and an external power and a consumed power state of the IoT device. The external power may be defined as, for example, various types of power supply devices, such as a constant power, a wireless charging device, and a solar charging device.

The priority profile 135 may include at least one of priority policy information predetermined when the electronic device 101 is manufactured or designed, priority information predetermined by a user, and priority setting information input from a user.

The memory 130 may include various programs related to IoT service support, algorithms, routines, and commands. The memory 130 may include instructions for instructing respective operations of the processor 120 mentioned in the description under the control of the processor 120.

The kernel 141 controls or manages system resources (e.g., the bus 110, the processor 120, or the memory 130) used for executing an operation or function implemented by the remaining other program, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 may be used, to the application 147.

The API 145 is an interface by which the application 147 may control a function provided by the kernel 141 or the middleware 142 and includes, for example, at least one interface or function (e.g., command) for a file control, a window control, image processing, or a character control.

The input/output interface 150 may be interface to transmit command or data inputted by a user or another external device to another component(s) of the electronic device 101. Further, the input/output interface 150 may output the command or data received from the other component(s) of the electronic device 101 to the user or the another external device.

The display 160 may include, for example, liquid crystal display (LCD), light emitting diode (LED), organic LED (OLED), or micro electro mechanical system (MEMS) display, or electronic paper display. The display 160 may display, for example, various contents (text, image, video, icon, or symbol, and so on) to a user. The display 160 may include a touch screen, and receive touch, gesture, approaching, or hovering input using a part of body of the user.

The communication interface 170 may set communication of the electronic device 101 and external device (e.g., a first external device 102, a second external device 104, or a server 106). For example, the communication interface 170 may be connected with the network 162 through wireless communication or wire communication and communicate with second external device 104 or server 106.

Wireless communication may use, as cellular communication protocol, at least one of long-term evolution (LTE), LTE Advance (LTE-A), code division multiple access (CDMA), wideband CDMA (WCDMA), universal mobile telecommunications system (UMTS), Wireless Broadband (WiBro), Global System for Mobile Communications (GSM), and the like, for example. A short-range communication 164 may include, for example, at least one of wireless-fidelity (Wi-Fi), Bluetooth (BT), near field communication (NFC), magnetic secure transmission or near field magnetic data stripe transmission (MST), and global navigation satellite system (GNSS), and the like.

An MST module is capable of generating pulses corresponding to transmission data using electromagnetic signals, so that the pulses can generate magnetic field signals. The electronic device 101 transmits the magnetic field signals to a point of sales (POS) terminal (reader). The POS terminal detects the magnetic field signal via an MST reader, transforms the detected magnetic field signal into an electrical signal, and thus restores the data.

The GNSS may include at least one of, for example, a global positioning system (GPS), a global navigation satellite system (Glonass), a Beidou Navigation Satellite System (hereinafter, referred to as “Beidou”), and Galileo (European global satellite-based navigation system). Hereinafter, “GPS” may be interchangeably used with “GNSS”. Wired communication may include, for example, at least one of universal serial bus (USB), high definition multimedia interface (HDMI), recommended standard-232 (RS-232), plain old telephone service (POTS), and the like. The network 162 may include telecommunication network, for example, at least one of a computer network (e.g., local area network (LAN) or wide-area network (WAN)), internet, and a telephone network.

Each of the first external device 102 and the second external device 104 may be same type or different type of device with the electronic device 101. The server 106 may include one or more group of servers. At least one portion of executions executed by the electronic device may be performed by one or more of the external electronic devices 102, 104, or server 106. When the electronic device 101 should perform a function or service automatically, the electronic device 101 may request performing of at least one function to the external electronic device 102, 104, or server 106. Cloud computing technology, distributed computing technology, or client-server computing technology may be used with the external electronic devices 102, 104, or server 106.

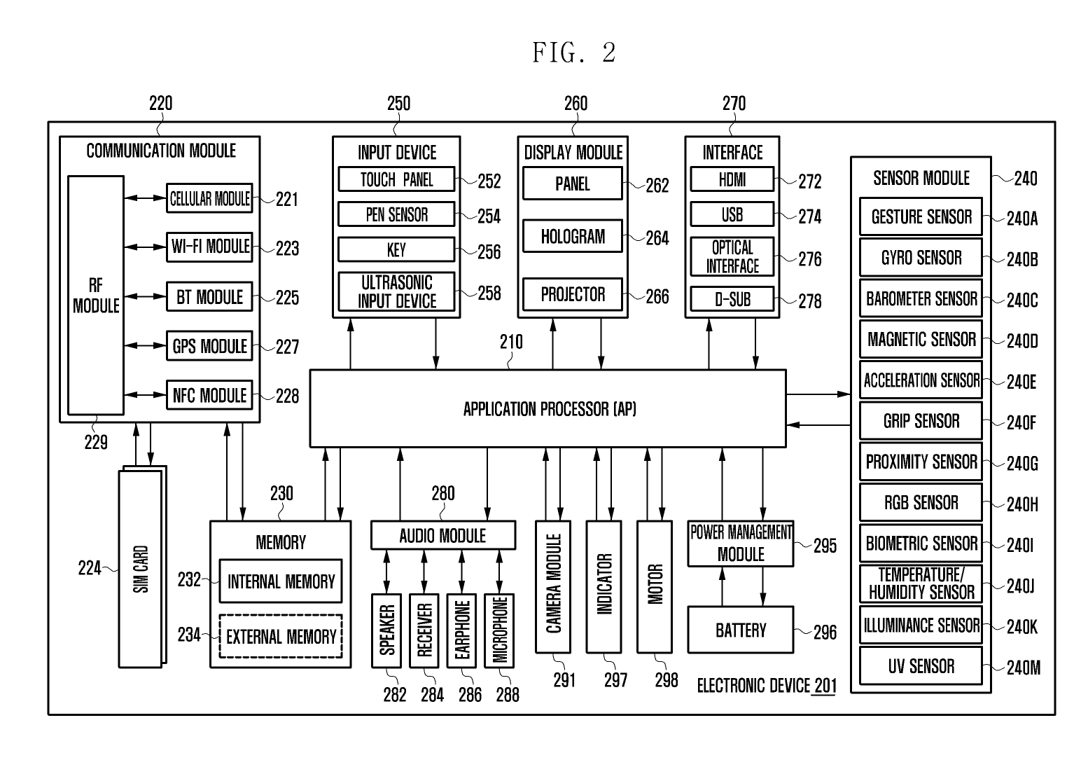

FIG. 2 is a block diagram of an electronic device, according to an embodiment of the present disclosure.

Referring to FIG. 2, an electronic device 201 may include all or some of the components of the electronic device 101 of FIG. 1. The electronic device 201 includes one or more APs 210, a communication module 220, a subscriber identification module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an OS or an application program so as to control a plurality of hardware or software component elements connected to the AP 210 and execute various data processing and calculations including multimedia data. The AP 210 may be implemented by, for example, a system on chip (SoC). The processor 210 may further include a graphics processing unit (GPU) and/or image signal processor. The AP 210 may include at least one portion of components illustrated in FIG. 2 (e.g., a cellular module 221). The AP 210 may load command or data received from at least one of another component (e.g., non-volatile memory), store various data in the non-volatile memory.

The communication module 220 may include the same or similar components as the communication interface 170 of FIG. 1. The communication module 220, for, example, may include the cellular module 221, a Wi-Fi module 223, a BT module 225, a GPS module 227, a NFC module 228, and a radio frequency (RF) module 229.

The cellular module 221 provides a voice, a call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using the SIM card 224. The cellular module 221 performs at least some of the functions which may be provided by the AP 210. For example, the cellular module 221 may perform at least some of the multimedia control functions. The cellular module 221 may include a CP.

Each of the Wi-Fi module 222, the BT module 223, the GPS module 224, and the NFC module 225 may include, for example, a processor for processing data transmitted/received through the corresponding module. Although the cellular module 221, the Wi-Fi module 222, the BT module 223, the GPS module 224, and the NFC module 225 are at least some (e.g., two or more) of the cellular module 221, the Wi-Fi module 222, the BT module 223, the GPS module 224, and the NFC module 225 may be included in one integrated chip (IC) or one IC package. For example, at least some (e.g., the CP corresponding to the cellular module 221 and the Wi-Fi processor corresponding to the Wi-Fi module 222 of the processors corresponding to the cellular module 221, the Wi-Fi module 222, the BT module 223, the GPS module 224, and the NFC module 225 may be implemented by one SoC.

The RF module 229 transmits/receives data, for example, an RF signal. Although not illustrated, the RF module 229 may include, for example, a transceiver, a power amp module (PAM), a frequency filter, a low noise amplifier (LNA) and the like. Further, the RF module 229 may further include a component for transmitting/receiving electronic waves over a free air space in wireless communication, for example, a conductor, a conducting wire, and the like. Although the cellular module 221, the Wi-Fi module 222, the BT module 223, the GPS module 224, and the NFC module 225 share one RF module 229 in FIG. 2, at least one of the cellular module 221, the Wi-Fi module 222, the BT module 223, the GPS module 224, and the NFC module 225 may transmit/receive an RF signal through a separate RF module.

The SIM card 224 may be inserted into a slot formed in a particular portion of the electronic device. The SIM card 224 includes unique identification information (e.g., integrated circuit card identifier (ICCID)) or subscriber information (e.g., international mobile subscriber identity (IMSI).

The memory 230 may include an internal memory 232 or an external memory 234. The internal memory 232 may include, for example, at least one of a volatile memory (e.g., a random access memory (RAM), a dynamic RAM (DRAM), a static RAM (SRAM), a synchronous dynamic RAM (SDRAM), and the like), and a non-volatile Memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, and the like).

The internal memory 232 may be a solid state drive (SSD). The external memory 234 may further include a flash drive, for example, a compact flash (CF), a secure digital (SD), a micro-SD, a mini-SD, an extreme digital (xD), or a memory stick. The external memory 234 may be functionally connected to the electronic device 201 through various interfaces. The electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (e.g., red, green, and blue (RGB) sensor) 240H, a biometric sensor 240I, a temperature/humidity sensor 240J, an illumination (light) sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor, and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which may detect an acoustic wave by a microphone (e.g., a microphone 288) of the electronic device 201 through an input means generating an ultrasonic signal to identify data and may perform wireless recognition. The electronic device 201 receives a user input from an external device (e.g., computer or server) connected to the electronic device 201 by using the communication module 220.

The display 260 includes a panel 262, a hologram device 264, and a projector 266. The panel 262 may be, for example, a LCD or an active matrix OLED (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 201. The display 260 may further include a control circuit for controlling the panel 262, the hologram device 264, and the projector 266.

The interface 270 includes, for example, a HDMI 272, an USB 274, an optical interface 276, and a d-subminiature (D-sub) 278. The interface 270 may be included in, for example, the communication interface 170 of FIG. 1. Additionally or alternatively, the interface 270 may include, for example, a mobile high-definition link (MHL) interface, an SD card/multi-media card (MMC), or an infrared data association (IrDA) standard interface.

The audio module 280 bi-directionally converts a sound and an electronic signal. At least some components of the audio module 280 may be included in, for example, the input/output interface 150 of FIG. 1. The audio module 280 processes sound information input or output through, for example, a speaker 282, a receiver 284, an earphone 286, the microphone 288 and the like.

The camera module 291 is a device which may photograph a still image and a video. The camera module 291 may include one or more image sensors (e.g., a front sensor or a back sensor), an image signal processor (ISP) or a flash (e.g., an LED or xenon lamp).

The power managing module 295 manages power of the electronic device 201. Although not illustrated, the power managing module 295 may include, for example, a power management integrated circuit (PMIC), a charger IC, or a battery gauge.

The PMIC may be mounted to, for example, an integrated circuit or an SoC semiconductor. A charging method may be divided into wired and wireless methods. The charger IC charges a battery and prevent over voltage or over current from flowing from a charger. The charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier and the like may be added.

The battery gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., AP 210) of the electronic device 201, for example, a booting status, a message status, a charging status and the like. The motor 298 converts an electrical signal to a mechanical vibration. Although not illustrated, the electronic device 201 may include a processing unit (e.g., GPU) for supporting a module TV. The processing unit for supporting the mobile TV may process, for example, media data according to a standard of digital multimedia broadcasting (DMB), digital video broadcasting (DVB), media flow and the like.

Each of the components of the electronic device 201 may be implemented by one or more components and the name of the corresponding component may vary depending on a type of the electronic device. The electronic device 201 may include at least one of the above described components, a few of the components may be omitted, or additional components may be further included. Also, some of the components of the electronic device 201 may be combined to form a single entity, and thus may equivalently execute functions of the corresponding components before being combined.

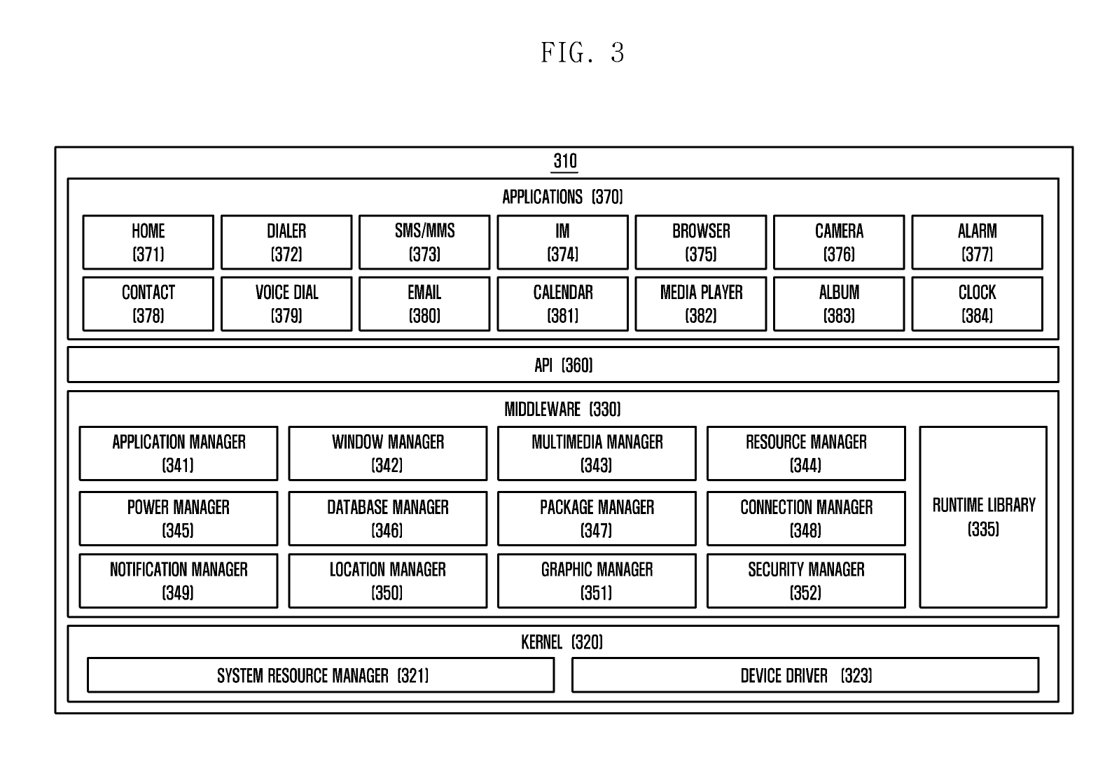

FIG. 3 is a block diagram illustrating a programming module, according to an embodiment of the present disclosure.

Referring to FIG. 3, a programming module 310 may be included, e.g. stored, in the electronic apparatus 100, e.g. the memory 130, of FIG. 1. At least a part of the programming module 310 may be configured by software, firmware, hardware, and/or combinations of two or more thereof. The programming module 310 may include an OS that is implemented in hardware, e.g., the hardware 200 to control resources related to the electronic device 100 and/or applications 370, driven on the OS. For example, the OS may be Android™, iOS™, Windows™, Symbian™, Tizen™, Bada™, and the like. Referring to FIG. 3, the programming module 310 may include a kernel 320, middleware 330, an API 360, and the applications 370. At least part of the program module 310 may be preloaded on the electronic device 102, 104, server 106, etc.

The kernel 320 may include a system resource manager 321 and/or a device driver 323. The system resource manager 321 may include, for example, a process manager, a memory manager, and a file system manager. The system resource manager 321 may control, allocate, and/or collect system resources. The device driver 323 may include, for example, a display driver, a camera driver, a BT driver, a shared memory driver, a USB driver, a keypad driver, a Wi-Fi driver, and an audio driver. Further, the device driver 323 may include an inter-process communication (IPC) driver.

The middleware 330 may include a plurality of modules implemented in advance for providing functions commonly used by the applications 370. Further, the middleware 330 may provide the functions through the API 360 such that the applications 370 may efficiently use restricted system resources within the electronic apparatus. For example, as shown in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352 and a payment manager 354.

The runtime library 335 may include a library module that a compiler uses in order to add a new function through a programming language while one of the applications 370 is being executed. The runtime library 335 may perform an input/output, memory management, and/or a function for an arithmetic function.

The application manager 341 may manage a life cycle of at least one of the applications 370. The window manager 342 may manage graphical user interface (GUI) resources used by a screen. The multimedia manager 343 may detect formats used for reproduction of various media files, and may perform encoding and/or decoding of a media file by using a codec suitable for the corresponding format. The resource manager 344 may manage resources such as a source code, a memory, and a storage space of at least one of the applications 370.

The power manager 345 may manage a battery and/or power, while operating together with a basic input/output system (BIOS), and may provide power information used for operation. The database manager 346 may manage generation, search, and/or change of a database to be used by at least one of the applications 370. The package manager 347 may manage installation and/or an update of an application distributed in a form of a package file.

For example, the connectivity manager 348 may manage wireless connectivity such as Wi-Fi or BT. The notification manager 349 may display and/or notify of an event, such as an arrival message, a promise, a proximity notification, and the like, in such a way that does not disturb a user. The location manager 350 may manage location information of an electronic apparatus. The graphic manager 351 may manage a graphic effect which will be provided to a user, and/or a user interface related to the graphic effect. The security manager 352 may provide all security functions used for system security and/or user authentication. When the electronic apparatus 100 has a telephone call function, the middleware 330 may further include a telephony manager for managing a voice and/or video communication function of the electronic apparatus. The payment manger 354 is capable of relaying payment information from the application 370 to an application 370 or a kernel 320. Alternatively, the payment manager 354 is capable of storing payment-related information received from an external device in the electronic device 200 or transmitting information stored in the electronic device 200 to an external device.

The middleware 330 may generate and use a new middleware module through various functional combinations of the aforementioned internal element modules. The middleware 330 may provide modules specialized according to types of OSs in order to provide differentiated functions. Further, the middleware 330 may dynamically remove some of the existing elements and/or add new elements. Accordingly, the middleware 330 may exclude some of the elements described herein, further include other elements, and/or substitute the elements with elements having a different name and performing a similar function.

The API 360, which may be similar to the API 133, is a set of API programming functions, and may be provided with a different configuration according to the OS. For example, in a case of Android™ or iOS™, one API set may be provided for each of platforms, and in a case of Tizen™, two or more API sets may be provided.

The applications 370, which may include an application similar to the application 147, may include, for example, a preloaded application and/or a third party application. The applications 370 may include one or more of the following: a home application 371 a dialer application 372, an SMS/multimedia messaging service (MMS) application 373, an instant messaging (IM) application 374, a browser application 375, a camera application 376, an alarm application 377, a contact application 378, a voice dial application 379, an email application 380, a calendar application 381, a media player application 382, an album application 383, a clock application 384, a payment application 385, a health care application (e.g., the measurement of blood pressure, exercise intensity, etc.), an application for providing environment information (e.g., atmospheric pressure, humidity, temperature, etc.), etc. However, the applications 370 may include any other similar and/or suitable application.

The applications 370 are capable of including an application for supporting information exchange between the electronic device 101 and the electronic devices 102 and 104, which is hereafter called ‘information exchange application’. The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, etc.) to the electronic devices 102 and 104. In addition, the notification relay application is capable of receiving notification information from external devices to provide the received information to the user.

The device management application is capable of managing (e.g., installing, removing or updating) at least one function of the electronic devices 102 and 104 communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

The applications 370 are capable of including an application (e.g., a health care application of a mobile medical device, etc.) specified attributes of the electronic devices 102 and 104. The applications 370 are capable of including applications received from the server 106, electronic devices 102 and 104. The applications 370 are capable of including a preloaded application or third party applications that can be downloaded from a server. It should be understood that the components of the program module 310 may be called different names according to types of operating systems.

At least part of the program module 310 can be implemented with software, firmware, hardware, or any combination thereof. At least part of the program module 310 can be implemented (e.g., executed) by the processors 120/210. At least part of the programing module 310 may include modules, programs, routines, sets of instructions or processes, etc., in order to perform one or more functions.

FIG. 4 is a block diagram illustrating devices that implement an IoT service, according to an embodiment of the present disclosure.

Devices that implement an IoT service may include an electronic device 101, a first external device (e.g., gateway 400), a server 500, and a second external device (e.g., IoT devices 600).

The IoT devices 600 may include IoT device 1 600A, IoT device 2 600B, and IoT device 3 600C. The IoT devices 600 may be various home devices that can be controlled or monitored by the electronic device 101.

The electronic device 101, the gateway 400, the server 500, and the IoT devices 600 may be connected to one another through short-range wireless communication. For example, the IoT devices 600 may support a short-range wireless communication type, such as Wi-Fi, ZigBee, Bluetooth, or z-wave, or another short-range wireless communication type. For example, the IoT device 1 600A may support Wi-Fi, the IoT device 2 600B may support ZigBee, and the IoT device 3 600C may support Bluetooth.

The IoT devices 600 may transmit situation information that corresponds to the IoT devices to the server 500 directly or indirectly in accordance with the communication type.

For example, the situation information that corresponds to the IoT device may be information related to the state of the IoT device 600 in association with the IoT device 600. For example, the situation information may be defined as log information (e.g., log information 1501) which may be changed in real time, event time, and device power information. Further, the situation information may include, for example, at least one of network state information of the IoT device and operation information of the IoT device.

The network state information of the IoT devices 600 may be information that indicates whether the IoT devices 600 is currently connected to communicate with at least one of the electronic device 101, the gateway 400, and the server 500 using a specific communication type.

The operation information of the IoT devices 600 may be information that indicates whether the IoT devices 600 currently performs the IoT service. For example, the operation information may include information that indicates whether the IoT devices 600 is currently turned on/off.

The event time of the IoT devices 600 may be information related to an event that is set in the IoT devices 600. For example, if an air conditioner is set to be turned on at three thirty, the three thirty may mean the event time for the air conditioner.

The IoT devices 600 power information may be information related to the power of the IoT devices 600. For example, the device power information may be information related to a connection state between the IoT devices 600 and an external power and a consumed power state of the IoT devices 600. The external power may mean, for example, various types of power supply devices, such as a constant power, a wireless charging device, and a solar charging device.

The IoT devices 600 that are unable to directly communicate with the server 500 may transmit the situation information that corresponds to the IoT devices 600 to the server under the support of the gateway 400.

Although IoT device 1 600a, IoT device 2 600b, and IoT device 3 600c are disclosed as an example of the IoT devices 600 in FIG. 4, the IoT devices 600 are not limited to the IoT devices 600a, 600b, and 600c. The gateway 400 may be included in the IoT devices 600.

The gateway 400 may be connected to the IoT devices 600. For example, the gateway 400 may receive and transmit the situation information that corresponds to the IoT devices 600 to the server 500 or the electronic device 101, or may transmit a control signal that is received from the server 500 or the electronic device 101 to the IoT devices 600.

The gateway 400 may convert a signal that is received from the electronic device 101 or the server 500 into a format that corresponds the communication type supported by the IoT devices 600 and may transmit the converted signal to the IoT devices 600. Further, the gateway 400 may convert a signal (e.g., situation information) that is received from the IoT devices 600 into a format that corresponds to the communication type supported by the server 500 or the electronic device 101 and may transmit the converted signal to the electronic device 101 or the server 500.

The gateway 400 may include at least one of the configurations of the electronic device 101 of FIG. 1.

The gateway 400 may include a sensor receiver 410, a processor 420, a memory 430, an input/output interface 450, a display 460, and a communication interface 470. The above-described configurations may perform the functions that correspond to the respective configurations of the electronic device 101 of FIG. 1, and the processor 420 of the gateway 400 may control the respective configurations as described above through execution of the IoT service. For example, the sensor receiver 410 can collect the signals that are generated by the IoT devices 600 and may be included in the communication interface 470. In accordance with the communication type that is supported by the IoT devices 600, the gateway 400 may collect the signals that are generated by the IoT devices 600 through at least one of the sensor receiver 410 and the communication interface 470.

The server 500 may be connected to at least one of the electronic device 101, the gateway 400, and the IoT devices 600 to transmit/receive the signal to/from them.

The server 500 may receive the situation information that corresponds to the IoT devices 600 from at least one of the IoT devices 600 and the gateway 400. Further, the server 500 may confirm an abnormal state of the gateway 400 or the server 500 or an abnormal state between the gateway 400 and the server 500, and may determine/select the electronic device 101 that can perform a backup function (gateway mode function) against the abnormal state. The server 500 may transmit a request for supplementing the function of the gateway 400 to the electronic device 101.

The server 500 may receive a signal for controlling at least one IoT devices 600 from the electronic device 101, and may convert the received signal in accordance with the communication type of the corresponding IoT devices 600. Further, the server 500 may transmit the converted signal to the gateway 400 or at least one IoT devices 600.

The server 500 may have information about the IoT devices to be controlled on the basis of the resource information (e.g., device profile 133) and priority information (e.g., priority profile 135).

The server 500 may provide authority information capable of controlling the IoT devices 600 to the electronic device 101.

The electronic device 101 may include the function of the server 500. Although the electronic device 101 and the server 500 are described in FIG. 4 as being separate components, the electronic device 101 may perform a partial function of the server 500.

The server 500 may include one of more components of the electronic device 101 of FIG. 1. The server 500 may include a processor 501, a memory 503, an input/output interface 505, a display 507, and a communication interface 509. The configurations as described above may perform the functions that correspond to the respective constituent elements of the electronic device 101 of FIG. 1, and the processor 501 of the server 500, and may control the respective constituent elements in accordance with the execution of the IoT service.

Further, although not illustrated in FIG. 4, the electronic device 101, the gateway 400, the server 500, and the IoT devices 600 in FIG. 4 may further include a configuration, such as the bus 110 of FIG. 1, to connect internal modules. Further, the electronic device 101, the gateway 400, the server 500, and the IoT devices 600 in FIG. 4 may include various configurations of FIGS. 2 and 3.

An electronic device may include a communication module; a memory configured to store resource information of a plurality of external devices including a first external device and a second external device that are connected through at least one short-range wireless communication; and a processor, wherein the processor is set to sense an abnormal state related to the first external device, determine the second external device as a backup device against the abnormal state based on at least the resource information, and to transmit a request for supplementing a function of the first external device related to the abnormal state to the second external device using the communication module.

The at least one short-range wireless communication of the electronic device may include a first short-range wireless communication and a second short-range wireless communication, and the first short-range wireless communication may include one of ZigBee, Wi-Fi, Bluetooth, and z-wave, and the second short-range wireless communication may include another of the ZigBee, Wi-Fi, Bluetooth, and z-wave.

The resource information of the electronic device may include a device identifier, a device location, a priority, a related device, a communication type, an event time of a device, a device power state, device log information, or a combination thereof.

The processor of the electronic device may be set so that the electronic device determines the backup device at least based on a priority.

The processor of the electronic device may be set to determine, based on a first priority for an external device related to an emergency service and a second priority for an external device related to an illumination service, a device that can communicate with the external device related to the first priority among the plurality of external devices to connect to the external device related to the first priority as the backup device.

The processor of the electronic device may be set to change the priority in accordance with situation information that corresponds to the external device.

The processor of the electronic device may be set to determine an electronic device that is supplied with a power by an external power as the backup device.

The processor of the electronic device may be set to determine a device that supports the short-range wireless communication type that has been performed by the first external device between the first short-range wireless communication and the second short-range wireless communication as the backup device.

The processor of the electronic device may be set to determine the second external device and a third external device among the plurality of external devices that further include the third external device as candidate devices for backing up the first external device, to transmit an inquiry on whether it is possible to back up a function related to the abnormal state of the first external device to the second external device and the third external device, and to determine the backup device at least based on a response to the inquiry that is received from the second external device or the third external device.

The processor of the electronic device may be set to transmit at least a part of authority information that is related to the plurality of external devices to the second external device.

The processor of the electronic device may be set to sense a normal state related to the first external device and to transmit a message for requesting deletion of the authority information or the resource information to the second external device.

The processor of the electronic device may be set to transmit a request for connecting at least one of the plurality of external devices to the second external device to the second external device based on a priority.

An electronic device includes a communication module; and a processor, wherein the processor is set to receive a request for performing a backup function for another electronic device of which an abnormal state is sensed among a plurality of external devices including the electronic device, which are connected through at least one short-range wireless communication, from the other electronic device or an external electronic device using the communication module, to receive resource information or authority information for at least parts of the plurality of electronic devices from the other electronic device or the external electronic device using the communication module based on at least the reception, and to perform a function related to the abnormal state of the other electronic device based on at least the resource information or the authority information.

The other electronic device of the electronic device may include a gateway, and the external electronic device may include a server.

The processor of the electronic device may be set to receive information that corresponds to the abnormal state from the other electronic device or the external electronic device before the reception of the performance request.

The processor of the electronic device may be set to determine whether the electronic device can perform the function and to transmit a response to the performance request to an electronic device that corresponds to the other electronic device or the external electronic device at least based on the determination.

The processor of the electronic device may be set to establish a communication connection with at least one of the plurality of electronic devices excluding the other electronic device at least based on a priority.

The processor of the electronic device may be set to establish the communication connection at least based on situation information related to the electronic device or the other electronic device.

The processor of the electronic device may be set to establish a communication connection with the first electronic device between the first electronic device and the second electronic device, which are connected to communicate with the other electronic device before the sensing of the abnormal state, among the plurality of electronic devices, and to refrain from establishing a communication connection with the second electronic device.

The processor of the electronic device may be set to perform at least a part of a gateway function for at least parts of the plurality of external devices.

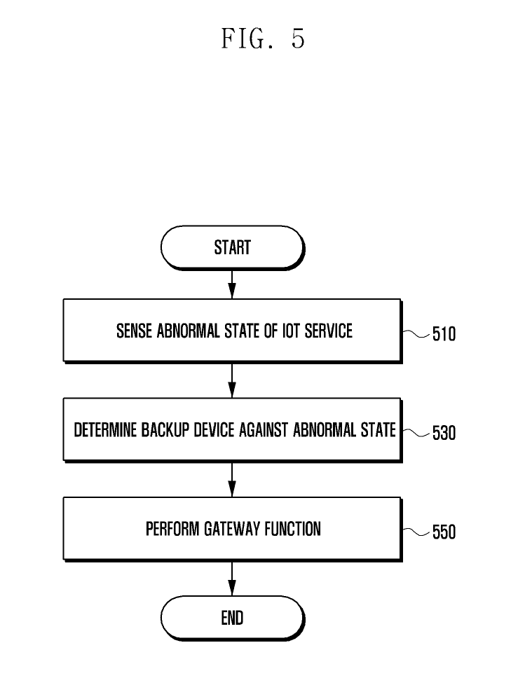

FIG. 5 is a flowchart of a method for an electronic device 101 or a server 500 to implement an IoT service, according to an embodiment of the present disclosure.

An electronic device 101 or a server 500 disclosed in FIG. 5 may execute an IoT service. For example, the processor 120 or the processor 501 may control the respective configurations of the electronic device 101 or the server 500 to implement an IoT service that is performed in an IoT system including the electronic device 101, a gateway 400, the server 500, and the IoT devices 600. Such IoT service execution may be performed in response to an activation operation of an application that is shared by at least one of the electronic device 101, the gateway 400, and the server 500. Further, the processor 120 or the processor 501 may control the respective configurations of the electronic device 101 or the server 500 to perform an operation related to the IoT service.

At step 510, processor 120 or the processor 501 may sense an abnormal state of the IoT service. The abnormal state of the IoT service may include at least one of an abnormal state of the gateway 400, an abnormal state of the server 500, and an abnormal state between the gateway 400 and the server 500.

The abnormal state of the gateway 400 may be defined as, for example, a state where the gateway 400 is unable to perform a function related to IoT service implementation temporarily or permanently in accordance with the defect or breakdown of the gateway 400. Further, the abnormal state of the gateway 400 may be defined as that the performance of the gateway 400 is not good, such as the performance deterioration of the gateway 400.

The abnormal state of the server 500 may be defined as, for example, a state where the server 500 is unable to perform a function related to IoT service implementation temporarily or permanently in accordance with the defect or breakdown of the server 500. Further, the abnormal state of the server 500 may be defined as that the performance of the server 500 is not good, such as the performance deterioration of the server 500.

The abnormal state between the gateway 400 and the server 500 may be defined as, for example, an abnormal state where a network connection state between the gateway 400 and the server 500 is unstable or impossible.

At step 530, the processor 120 or the processor 501 may select a backup device when the abnormal state is sensed. For example, the electronic device 101 or the server 500 may select the electronic device 102 or electronic device 104 as a backup device for performing a function related to the abnormal state in order to supplement the abnormal state related to the gateway 400. The second external device may be the same as the electronic device 101 of FIGS. 1 to 4 or may include at least a partial configuration of the electronic device 101. The second external device may perform a gateway mode.

The electronic device 101 or the server 500 may store resource information (e.g., device profile 133) for the plurality of external devices including the gateway 400 and the second external device.

The processor 120 or the processor 501 may select a device that is designated by the electronic device 101 or the server 500 as a backup device based on the priority. For example, the electronic device 101 or the server 500 may determine a device that can communicate with a device related to an emergency service, such as a gas sensor device, through the short-range wireless communication as a backup device in accordance with the priority. Further, the electronic device 101 or the server 500 may select a device that can communicate with a device related to a security service, such as a door lock device, through the short-range wireless communication as a backup device in accordance with the priority. For example, the electronic device 101 or the server 500 may designate a device related to an emergency and security service at the first priority and a device related to the previous control device at the second priority. The electronic device 101 or the server 500 may select a device that can communicate with the device related to the first priority among the plurality of external devices as a backup device in order to connect to the device related to the first priority, for example, based on the priority. However, if it is not possible to select the device that can communicate with the device related to the first priority as a backup device, the electronic device 101 or the server 500 may select the device that can communicate with the device related to the second priority as a backup device.

The processor 120 or the processor 501 may select the backup device through changing of the priority in accordance with situation information that corresponds to the plurality of external devices (e.g., IoT devices 600). For example, the processor 120 or the processor 501 may change the priority based on the power situation of the plurality of external devices (e.g., IoT devices 600). For example, if a device that is supplied with a power by an external power among the plurality of external devices (e.g., IoT devices 600) is sensed, the sensed device may be selected as a backup device. Further, the electronic device 101 or the server 500 may select a device having the smallest power amount that is consumed for a predetermined time among the plurality of devices and may select the device as a backup device based on the determination.

The processor 120 or the processor 501 may change the priority based on log information. For example, the processor 120 or the processor 501 may select the device that supports the communication type of the device that has performed the short-range wireless communication with the gateway 400 during sensing of the abnormal state of the IoT service as a backup device.

The electronic device 101 or the server 500 may select the device, which supports the short-range wireless communication type that has been performed by the first external device between the first short-range wireless communication type (e.g., Wi-Fi) and the second short-range wireless communication type (e.g., ZigBee) during sensing of the abnormal state related to the gateway 400, as a backup device. For example, if an abnormal state related to the gateway 400 is sensed while the gateway 400 and IoT device 1 600A communicate with each other using the ZigBee communication type, the electronic device 101 or the server 500 may confirm the device that supports the ZigBee communication type among the IoT devices 600 and may select the confirmed device as a backup device.

The processor 120 or the processor 501 may determine the second external device and the third external device among the plurality of external devices as candidate devices for backing up the gateway 400, and may transmit an inquiry as to whether it is possible to back up a function related to the abnormal state of the gateway 400 to the second external device and the third external device. Further, the 120 or the processor 501 may determine the backup device at least based on a response to the inquiry that is received from the second external device or the third external device. For example, the electronic device 101 or the server 500 may determine IoT device 1 600A and the IoT device 600B among the IoT devices 600 as candidate devices for backing up the gateway 400. For example, the electronic device 101 or the server 500 may transmit an inquiry message as to whether the determined candidate devices can back up the function of the gateway 400 to IoT device 1 600A and the IoT device 600B. For example, if the backup is possible through confirmation of the capability, IoT device 1 600A and the IoT device 600B may transmit a response message indicating that the backup is possible to the electronic device 101 or the server 500. Based on the response message, the electronic device 101 or the server 500 may select at least one of IoT device 1 600A and the IoT device 600B as a backup device.

At step 530, the processor 120 or the processor 501 may transmit a request for supplementing the gateway 400 to the selected backup device (second external device).

At step 550, the second external device may perform the function of the gateway 400. Since the second external device can perform at least a partial function of the electronic device 101 as described above, the second external device, at step 550 can perform the gateway function.

The processor 120 or the processor 501 may transmit a request for the external device of which the connection is to be performed among the plurality of external devices to the backup device (second external device) based on the priority. For example, if a connection to a gas sensor device is required in accordance with the priority, the processor 120 or the processor 501 may transfer a message for requesting a connection to the gas sensor device to the backup device.

The electronic device 101 may perform the function of the gateway 400 related to the first external device (e.g., IoT devices 600). For example, the electronic device 101 may connect to the IoT devices 600 in place of or in supplement to a network between the gateway 400 and the server 500, and may update the situation information that is received from the connected IoT devices 600. Further, the electronic device 101 may transmit the situation information which corresponds to the IoT devices 600 and is received from the gateway 400 to the server 500. The detailed operation of the device of FIG. 5 will be described in more detail below.

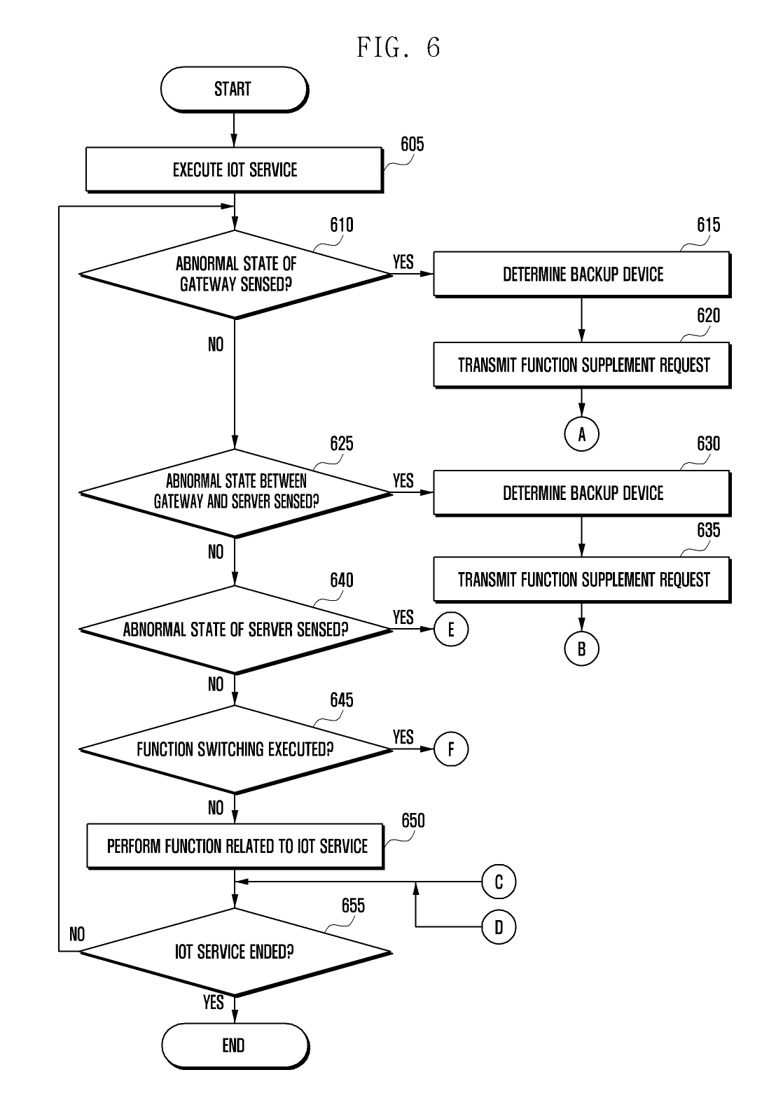

FIG. 6 is a flowchart of a method for an electronic device 101 or a server 500 to implement an IoT service, according to an embodiment of the present disclosure.

At step 605, the processor 120 or the processor 501 may execute the IoT service. For example, the processor 120 or the processor 501 may control the respective configurations of the electronic device 101 or the server 500 to perform the function of the electronic device 101 or the server 500 that is related to the IoT service through execution of an application related to the IoT service. Further, the processor 120 or the processor 501 may be requested to perform the function related to the IoT service from the application related to the IoT service.

At step 610, the processor 120 or the processor 501 may determine whether the abnormal state of the gateway 400 is sensed. For example, the processor 120 or the processor 501 may sense the abnormal state of the gateway 400 based on whether the signal that is transmitted/received through the gateway 400 continues. Further, the processor 120 or the processor 501 may sense the abnormal state of the gateway 400 through reception of the signal indicating that the breakdown of the gateway 400 has occurred from the gateway 400.

At step 615, the processor 120 or the processor 501 may determine the external device (e.g., backup device) that can perform the function related to the abnormal state of the gateway 400.

Further, at step 620, the processor 120 or the processor 501 may transmit a signal for requesting supplement of the function of the gateway 400 to the determined external device (e.g., backup device).

At least one electronic device (e.g., gateway 400) among a plurality of electronic devices that are connected through at least one short-range wireless communication may request performance of the backup function for the gateway 400 of which the abnormal state has been sensed using the short-range wireless communication (e.g., ZigBee, Wi-Fi, Bluetooth, or z-wave) device that corresponds to the at least one short-range wireless communication. Further, the server 500 may transmit a backup function performance request for the gateway 400 of which the abnormal state has been sensed to the external device (e.g., backup device) using the wireless communication (e.g., LTE or Internet). At least one electronic device or the external electronic device may transmit information that corresponds to the abnormal state to the external device (e.g., backup device) before the reception of the backup function performance request.

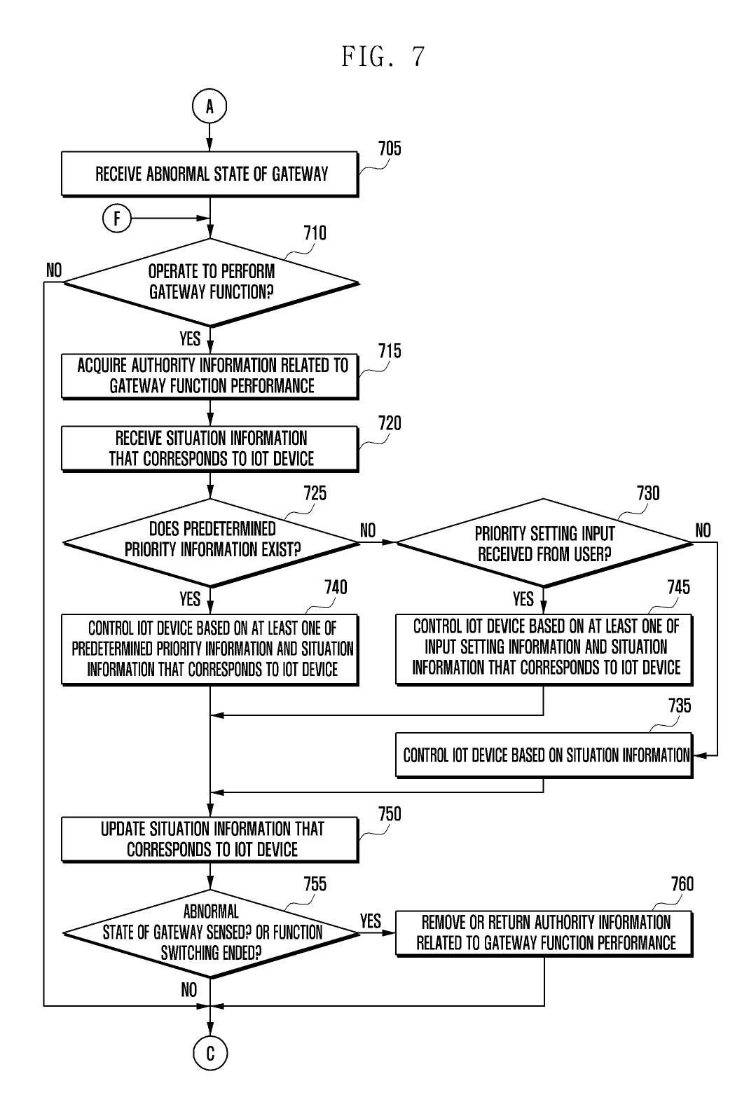

The detailed operation of the external device (e.g., backup device) in the case where the abnormal state of the gateway 400 is sensed will be described with reference to FIG. 7.

At step 625, the processor 120 or the processor 501 may determine whether the abnormal state between the gateway 400 and the server 500 is sensed. The abnormal state between the gateway 400 and the server 500 may be defined as a state where transmission/reception of the signal related to the IoT service implementation between the gateway 400 and the server 500 is impossible or is not good due to at least one breakdown of one or more pieces of hardware, one or more pieces of software, and one or more pieces of firmware that constitute the network. The processor 120 or the processor 501 may sense the abnormal state between the gateway 400 and the server 500 based on whether the signal that is transmitted/received through the gateway 400 continues. Further, the processor 120 or the processor 501 may sense the abnormal state of the network through reception of the signal indicating that the network is currently in an abnormal state from at least one communication module constituting the network.

At step 630, the processor 120 or the processor 501 may determine the external device (e.g., backup device) that can supplement the abnormal state of the gateway 400 in accordance with the abnormal state between the gateway 400 and the server 500.

Further, at step 635, the electronic device 101 or the server 500 may transmit a signal for requesting supplement of the function of the gateway 400 to the selected external device (e.g., backup device).

The plurality of electronic devices (e.g., gateway 400) that are connected through at least one short-range wireless communication may request performance of the backup function for the electronic device of which the abnormal state has been sensed using the short-range wireless communication (e.g., ZigBee, Wi-Fi, or Bluetooth) that corresponds to the at least one short-range wireless communication. Further, the external electronic devices (e.g., server 500) may request performance of the backup function for the electronic device of which the abnormal state has been sensed using the wireless communication (e.g., LTE or Internet).

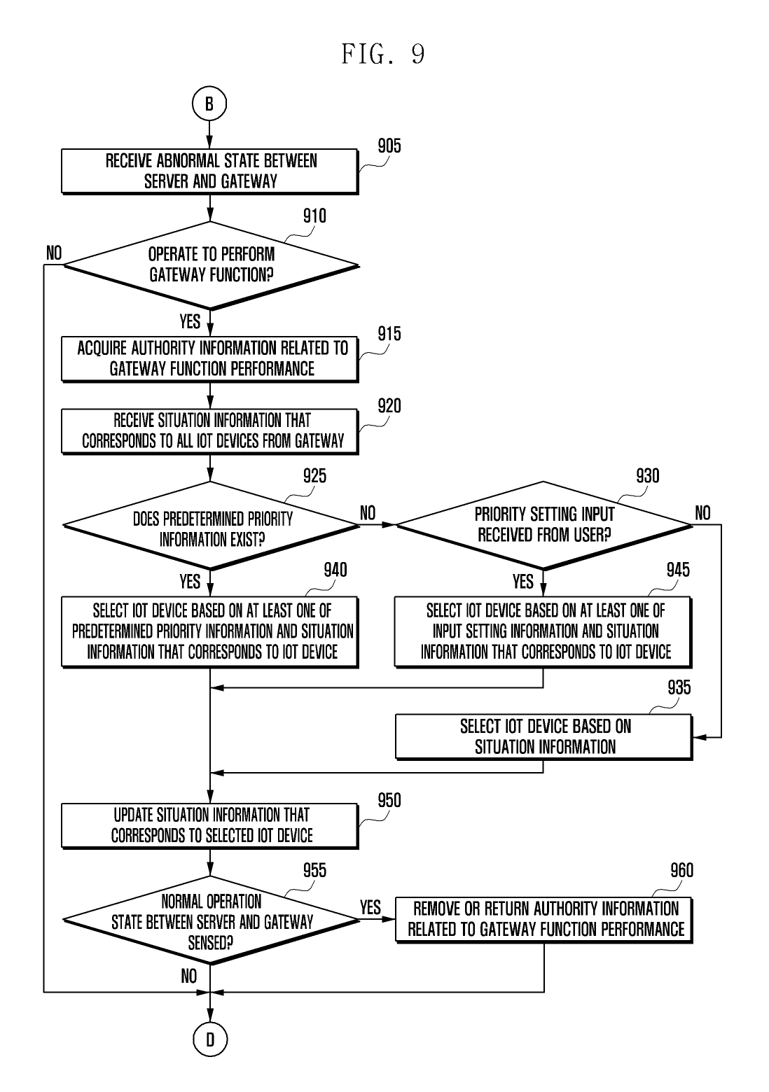

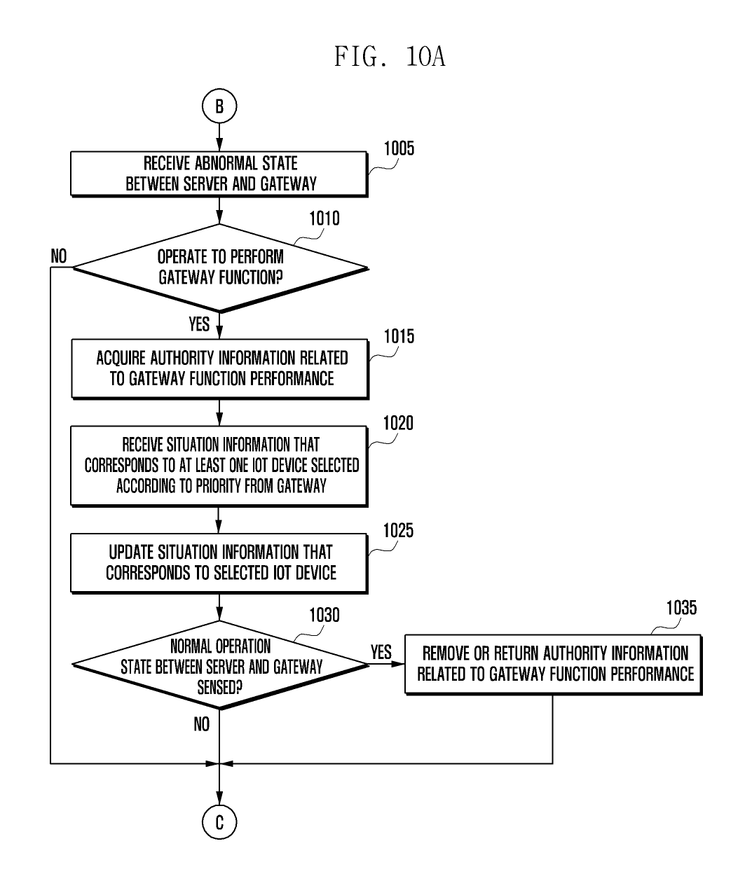

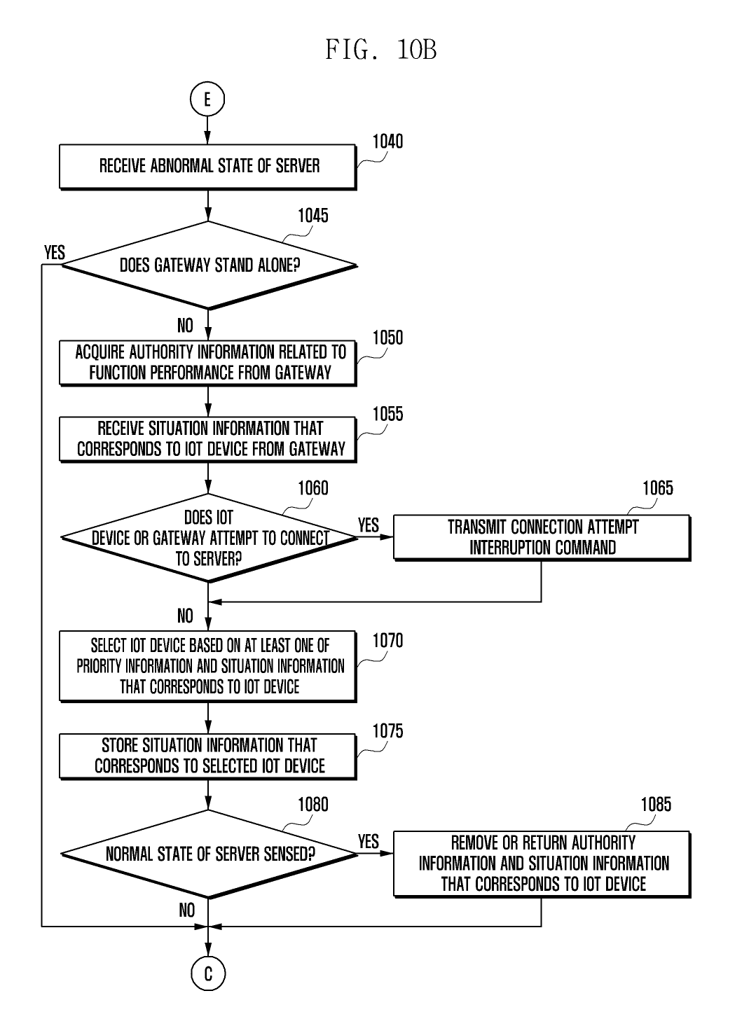

At least one of the electronic device or the external electronic device may transmit information that corresponds to the abnormal state to the external device (e.g., backup device) before the reception of the backup function performance request. The detailed operation of the external device (e.g., backup device) in the case where the abnormal state between the gateway 400 and the server 500 is sensed will be described with reference to FIGS. 9 and 10A.

At step 640, the processor 120 or the processor 501 may confirm whether the abnormal state of the server 500 is sensed. The electronic device 101 or the server may sense the abnormal state of the server 500 through various methods. For example, when the electronic device 101 and the gateway 400 have attempted to connect to the server, but their connection attempts have failed in all, the electronic device 101 may sense the abnormal state of the server 500.

Further, the electronic device 101 may determine the abnormal state of the server 500 through a direct connection to the gateway 400 or a connection to the gateway 400 through an external network. If the performance state of the server 500 becomes equal to or lower than a predetermined level, the server 500 may notify the electronic device 101 or the gateway 400 that the abnormal state of the server 500 has occurred in accordance with a determined policy.

The detailed operation of the electronic device 101 in the case where the abnormal state of the server 500 is sensed will be described with reference to FIG. 10B.

At step 645, the electronic device 101 may determine whether to execute a switching function. The execution of the switching function may be an operation that is requested for the electronic device 101 to perform at least a part of the function of the gateway 400 even if the abnormal state of the IoT service has not occurred. The operation of the electronic device 101 in the case where the execution of the switching function is requested may be a partial operation of FIG. 7, described below. A user of the electronic device 101 can prevent an unintended connection to the server 500, and can collect data access flow or frequency from the IoT devices 600.

If execution of the switching function is not requested, at step 650, the processor 120 or the processor 120 may perform a function of the electronic device 101 related to the IoT service.

At step 655, the processor 120 may receive an input as to whether to end the IoT service. In the case of receiving an input through which the IoT service is not ended, the electronic device 101 may proceed to step 610 to perform a subsequent process to step 610. In the case of receiving an input through which the IoT service is ended, the electronic device 101 may end the IoT service performance operation or support operation.

FIG. 6 illustrates the sensing of the abnormal state of the gateway 400, the sensing of the abnormal state between the gateway 400 and the server 500, and the sensing of the abnormal state of the server 500 in no particular order. However, an order may be changed, or the operations as described above may be performed in parallel.

FIG. 7 is a flowchart of a method for an electronic device to implement an IoT service as an abnormal state of an external device (e.g., gateway 400) is sensed, according to an embodiment of the present disclosure.

Since the external device that is selected as the backup device in FIGS. 5 and 6 may be the same as the electronic device 101 or may include at least a part of the configuration of the electronic device 101, the external device (e.g., second external device) that is selected as the backup device will be described with respect to the electronic device 101.

At step 705, the processor 120 may receive the abnormal state of the gateway 400. For example, the electronic device 101 may receive the abnormal state of the gateway 400 from the server 500 or the gateway 400. The electronic device 101 may display a user interface (UI) screen indicating that the abnormal state of the gateway 400 has been sensed or received to correspond to the reception.

At step 710, the processor 120 may inquire whether to perform a gateway mode. For example, the processor 120 may inquire of a user whether the electronic device 101 operates to perform the function of the gateway 400. The electronic device 101 may output such an inquiry through the display 160 or the audio module 280. For example, the processor 120 may display an inquiry screen as to whether to perform a gateway mode operation in the form of a UI item through the display 160, or may output the inquiry on whether to perform the gateway mode operation as audio through the audio module 280.

The electronic device 101 may perform the gateway mode in accordance with a predetermined policy. The predetermined policy may include a policy to automatically activate the gateway mode if an operation command signal of the gateway mode is not received for a specific time and a policy to automatically activate the gateway mode without any separate command in a specific time.

At step 710, the processor 120 may determine whether to perform the gateway mode. For example, the electronic device 101 may determine whether to perform the gateway mode based on capability that can be supported by the electronic device 101. For example, if a connection request for a device to be connected through ZigBee is received from the server 500, the electronic device 101 may determine whether it can support ZigBee, and if so, the electronic device 101 may determine whether to perform the gateway function.

Although not illustrated, the electronic device 101 may receive a backup function performance request from at least one of other electronic devices or an external electronic device. For example, the electronic device 101 may receive the backup function performance request from the gateway 400 using the short-range wireless communication (e.g., ZigBee communication) that corresponds to at least one short-range wireless communication. For example, the electronic device 101 may receive the backup function performance request from the server 500 using the wireless communication (e.g., LTE or Internet).

The electronic device 101 may determine whether to perform the backup function, and may transmit a response to the performance request to the corresponding electronic device among the other electronic devices or the external electronic devices at least based on the determination.

Based on the determination that makes the electronic device 101 operate in the gateway mode, at step 715, the processor 120 may acquire authority information related to the function performance of the gateway 400 from the server 500. For example, the processor 120 may receive the authority information for executing the gateway mode from the server 500 through the communication interface 170. For example, transmission of such authority information may be performed using an algorithm using a channel encryption key or a data encryption key. The electronic device 101 may perform message authentication with the server 500 through exchange of a supportable algorithm with the server 500, encryption key exchange, authentication, and encryption with a symmetric-key cryptosystem.

The electronic device 101 and the server 500 may store the same authentication key algorithm or an authentication key algorithm in which encryption and decryption are mutually possible. The server 500 may generate authentication information (e.g., figures and texts) that has been previously transmitted/received through the electronic device 101 as an authentication key using the authentication key algorithm, and may transmit the generated authentication key to the electronic device 101.

The electronic device 101 may decrypt the authentication key using the authentication key algorithm, and if the decrypted authentication information coincides with the authentication information that is previously received from the server 500, the electronic device 101 may transmit information indicating that the decrypted authentication information is the same as the authentication information that has been previously received from the server 500 to the server 500. The server 500 may transmit the authority information to the electronic device 101 in response to this, and the processor 120 may receive the authority information and control the respective configurations of the electronic device 101 to activate various configurations and programs related to the function of the gateway 400.

The electronic device 101 may perform the function related to the gateway 400 through acquisition of the authority information as described above. The IoT service may allow only the electronic device 101 to which the server 500 has transmitted the authority information to perform the function of the gateway 500, and thus can prevent the unintended electronic device 101 from performing the IoT service.

The second external device that is selected as the backup device may acquire at least a part of the authority information related to the gateway function performance from the processor 120. The second external device may activate various configurations and programs related to the function of the gateway 400 through reception of the at least a part of the authority information.

Although the above-described step 715 is performed based on the determination to make the electronic device 101 operate in the gateway mode, the present disclosure are not limited thereto. For example, the electronic device 101 may automatically perform the gateway mode even without any user's input in accordance with a predetermined policy. The predetermined policy is information that is related to a condition to make the electronic device 101 automatically operate in the gateway mode when the abnormal state of the gateway 400 is sensed, and may be stored or changed when the electronic device 101 is designed or manufactured or any time in accordance with the user's input.

If the electronic device 101 does not operate in the gateway mode, it may branch to step 655 of FIG. 6 to receive a selection input on whether to end the IoT service from the user.

At step 720, the processor 120 may receive situation information that corresponds to the IoT devices 600 from the server 500. For example, the processor 120 may receive the situation information that corresponds to at least one of the IoT devices 600 from the server 500 through the communication interface 170. Further, although not illustrated in the FIGs., the processor 120 may receive resource information related to the IoT devices 600 from the server 500 through the communication interface 170.

Although FIG. 7 illustrates that the electronic device 101 receives the situation information after acquiring the authority information; however, the present disclosure is not limited thereto. For example, the electronic device 101 may acquire the authority information after receiving the situation information, or may acquire the situation information and the authority information simultaneously.

At step 725, the processor 120 may determine whether predetermined priority information exists. For example, the processor 120 may determine whether the predetermined priority information exists with reference to the memory 130. The priority information may be stored in the priority profile 135 of the memory 130.

The electronic device 101 may acquire the priority information that is stored in another electronic device (e.g., gateway 400 or IoT devices 600) or a web through the communication interface 170. In addition, the priority information may be predetermined in the server 500, and the electronic device 101 may receive the priority information from the server 500.

If the predetermined priority information exists, the electronic device 101, at step 740, may connect to at least one of the IoT devices 600 based on at least one of the predetermined priority information and the situation information that corresponds to the IoT device. For example, the processor 120 may confirm a connectable IoT device, identification information of the corresponding IoT device, network state information, communication type information, and operation information based on the situation information that corresponds to the IoT device. Further, the processor 120 may connect to at least one of the confirmed IoT devices in accordance with the predetermined priority information. For example, the processor 120 may establish a communication connection with at least one IoT device through the communication interface 170 in accordance with the predetermined priority information.

The processor 120 may confirm the communication type information of the corresponding IoT device, and may establish a communication connection with the corresponding IoT device in accordance with the confirmed communication type information. For example, the processor 120 may confirm that the corresponding IoT device supports the Wi-Fi communication type based on the situation information that corresponds to the corresponding IoT device, and may connect to the corresponding IoT device through the Wi-Fi module 223.

The processor 120 may establish a communication connection with the first electronic device between the first electronic device and the second electronic device, which are connected to communicate with at least one electronic device (e.g., gateway 400) before the sensing of the abnormal state, among the plurality of electronic devices, and may refrain from establishing a communication connection with the second electronic device.

If the processor 120 is connected to at least one IoT device, it may control the at least one IoT device. For example, the processor 120 may directly transmit a control signal to at least one IoT device, or may control the at least one IoT device via the server 500.

The processor 120 may transmit a signal for controlling at least one IoT device and a signal for requesting forwarding of the control signal to the IoT device to the server 500. For example, the server 500 may forward the control signal to the IoT device in response to the reception of the request signal.

The processor 120 may transmit a signal for requesting control of at least one IoT device to the server 500, and the server 500 may generate a new control signal for itself based on the received request signal and transmit the generated control signal to the IoT device.

The control signal may be a signal for instructing the operation of at least one IoT device. For example, the control signal may be a signal for instructing an on/off operation or a specific function of the IoT device.

If the processor 120 is connected to at least one IoT device, it can monitor the at least one IoT device. For example, the processor 120 may receive the situation information that corresponds to the corresponding IoT device from at least one IoT device in real time or periodically.

The processor 120 may provide the situation information that corresponds to the IoT device and is received through the communication interface 170 to the user. For example, the processor 120 may output the situation information that corresponds to the IoT device and is received from at least one of the IoT device and the server 500 in real time or periodically through the gateway 400. Through the above-described operation, the electronic device 101 may control at least one IoT device that has been managed through the gateway 400 in place of the gateway 400 that cannot currently support the IoT service.

If the predetermined priority information does not exist, the electronic device 101, at step 730, may determine whether a priority setting input is received from a user. For example, if the priority of the IoT devices 600 to be connected by the electronic device 101 is not predetermined, the electronic device 101 may manually receive the priority information from the user. For example, the processor 120 may receive setting of the priority information, or may output a UI screen for receiving an input of the priority information through the display 160.

If the priority setting input is received from the user, the electronic device 101, at step 745, may control the IoT device based on at least one of the input priority setting information and the situation information that corresponds to the IoT device.

For example, the processor 120 may confirm a connectable IoT device, identification information of the corresponding IoT device, network state information, communication type information, and operation information based on the situation information that corresponds to the IoT device and resource information. Further, the processor 120 may connect to at least one of the confirmed IoT devices in accordance with the priority setting information that is input from the user. The processor 120 may establish a communication connection with at least one IoT device in accordance with the priority setting information that is input from the user. Further, the processor 120 may store the priority setting information that is input from the user in the memory 130 or the priority profile 135.

The electronic device 101 may control at least one IoT device based on the connection to the at least one IoT device. Further, the electronic device 101 may receive the situation information that corresponds to at least one IoT device. In the same manner as described above, the control signal may be a signal for instructing the operation of at least one IoT device, and the processor 120 may receive the situation information that corresponds to the at least one IoT device through at least one of the communication interface 170 and the server 500 in real time or periodically from the corresponding IoT device.

If the priority setting input is not received from the user, the processor 120, at step 735, may connect to the IoT device based on the situation information. For example, the processor 120 may confirm currently connected devices, and may establish a communication connection with the confirmed IoT devices. The electronic device 101 may control the operation of the connected IoT devices or may receive the situation information.

At steps 735, 740, and 745, the IoT device may be controlled at least based on the priority or the situation information related to the IoT device. The control of the IoT device may include establishment of a communication connection with the IoT devices, and the establishment of the communication connection may be performed using the short-range wireless communication (e.g., Wi-Fi, ZigBee, Bluetooth, or z-wave) and the wireless communication (e.g., LTE or Internet).

At step 750, the processor 120 may update the situation information that corresponds to the IoT device. For example, the processor 120 may receive the situation information that corresponds to at least one communication-connected IoT device from the corresponding IoT device, and may transmit the received situation information to the server 500.

The processor 120 may transmit the situation information that corresponds to the IoT device and a signal for storing or updating the situation information in the memory 530 of the server 500 to the server 500. Through this, the electronic device 101 may update the situation information that corresponds to the IoT device and is stored in the server 500.

The processor 120 may update the situation information that corresponds to the corresponding IoT device and is previously stored in the memory 130 with the situation information that is received from at least one IoT device. The previous situation information may be currently connected to the electronic device 101, or may be previously received from at least one unconnected IoT device to be stored in the memory 130. Through this, the electronic device 101 may update the situation information that corresponds to the IoT device and is stored in the memory 130.

Although not illustrated, the electronic device 101 may control the IoT device or update the situation information that corresponds to the IoT device in consideration of the priority information and log information included in the situation information that corresponds to the IoT device. The log information of the IoT device may include time information when at least one IoT device is connected to communicate with the gateway 400 or the electronic device 101 and data transmission success/failure information. The log information may be recorded in the server 500 through the gateway 400 or the electronic device 101.

The processor 120 may receive the log information of at least one IoT device from the server 500 in real time or periodically. The processor 120 may perform at least one of steps 735, 740, and 745, in consideration of the received log information of the IoT device. For example, the processor 120 may connect to the IoT device based on at least one of predetermined priority information, situation information that corresponds to the IoT device, and log information of the IoT device included in the situation information.

The electronic device 101 may set the log information of the IoT device as a weight value, and may reflect the set log information in at least one of the situation information that corresponds to the IoT device and the priority information.

Although not illustrated, the processor 120 or the server 500 may sense the abnormal state of the gateway 400 or the abnormal state between the gateway 400 and the server 500 based on the log information of the IoT device. The processor 120 or the server 500 may receive the log information of the IoT device from the gateway 400, and may confirm the abnormal state of the gateway 400 or the abnormal state between the gateway 400 and the server 500 through analysis of the received log information. For example, with reference to the log information, there may be a record in which the gateway 400 transmits/receives data with the electronic device 101, but the corresponding data related record may not be shared by the server 500.

The electronic device 101 or the server 500 may determine the abnormal state between the gateway 400 and the server 500 based on the information as described above.

Further, as another example, when referring to the log information, the gateway 400 may not transmit the data (situation information that corresponds to the IoT device) to both the electronic device 101 and the server 500 after a predetermined time. The electronic device 101 or the server 500 may determine that the gateway 400 is in an abnormal state based on the information as described above.

At step 755, the processor 120 may determine whether a normal state of the gateway 400 is sensed. For example, the electronic device 101 may sense whether the gateway 400 operates again in the normal state while executing the gateway mode in accordance with the abnormal state of the gateway 400. The normal state may mean a state where the gateway 400 can perform at least a part of the function of the gateway 400.

The processor 120 may sense whether the gateway 400 operates in the normal state based on the information that is received from the server 500. For example, if the information (e.g., situation information that corresponds to the IoT device) related to the function performance of the gateway 400, of which the reception from the gateway 400 was interrupted, is re-received, the server 500 may determine that the gateway 400 has been switched to the normal state, and may transmit such determination information to the electronic device 101.

The processor 120 may determine that the gateway 400 has been switched to the normal state through reception of the information related to the function performance of the gateway 400 via the server 500.

If the normal state of the gateway 400 is sensed, the processor 120, at step 760, may remove or return the authority information related to the function performance of the gateway 400 to the server 500. For example, if the normal state of the gateway 400 is sensed, the processor 120 may transmit a control signal for deleting the authority information or returning the stored authority information to the server 500 to the memory 130. Through this, the gateway mode of the electronic device 101 is released, or the performance of at least a part of the function of the gateway mode is restricted, and thus the processor 120 can control the electronic device 101 not to perform the duplicate function with the gateway 400 that has been switched to the normal state.

The server 500 may transmit a message for requesting deletion of the authority information or the resource information to the electronic device 101 as it senses the normal state related to the gateway 400. Through this, the gateway mode of the electronic device 101 may be released, or the performance of at least a part of the function of the gateway mode may be restricted.

If the normal state of the gateway 400 is not sensed, the electronic device 101 may proceed to step 655 of FIG. 6 to receive a selection input on whether to end the IoT service from the user.

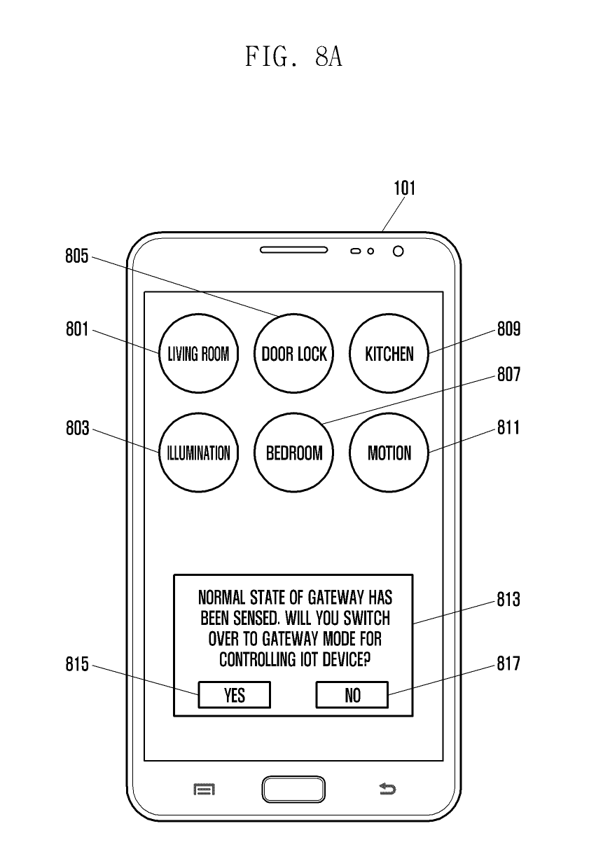

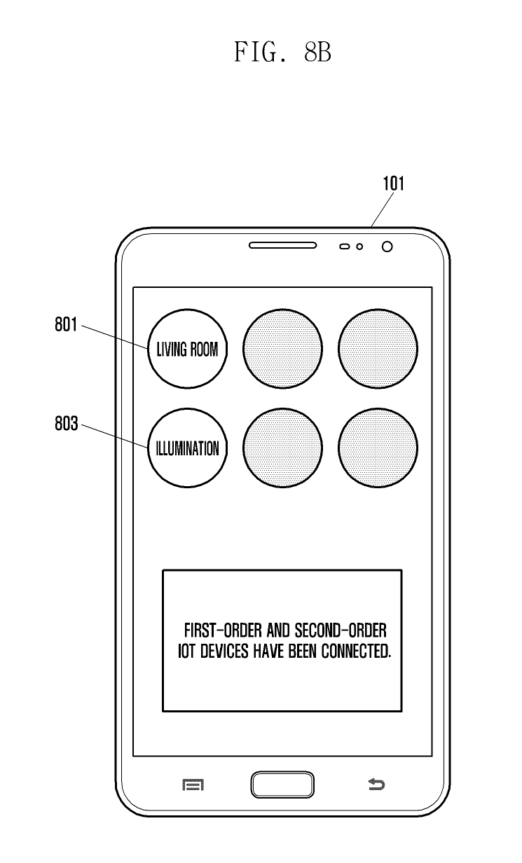

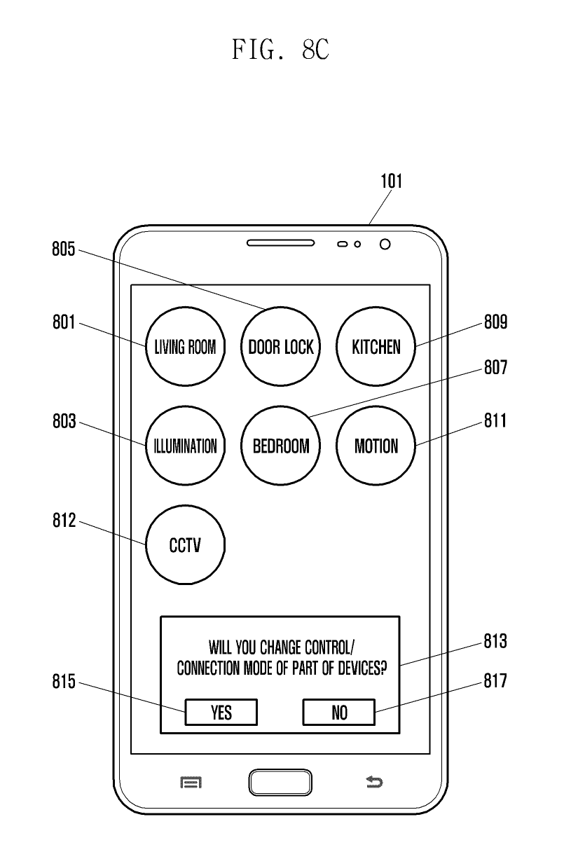

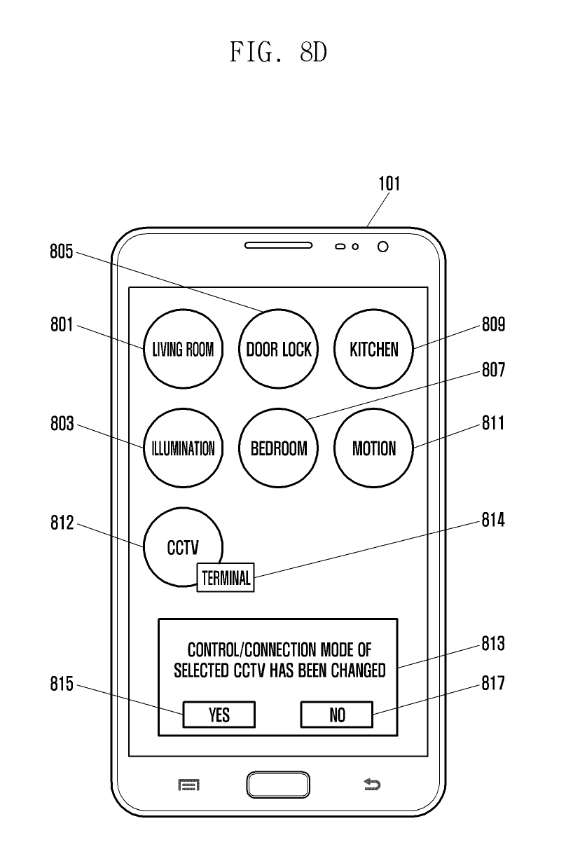

The electronic device 101 may directly request function switching performance even if the abnormal state of the gateway 400, the abnormal state between the gateway 400 and the server 500, or the abnormal state of the server 500 is not sensed. In this case, at step 710, the electronic device 101 may perform at least a part of the function of the gateway 400. Further, at step 755, the processor 120 may sense whether the function switching is ended, and may perform steps 760 or 655 in accordance with the result of sensing. The detailed example of such an operation will be described with reference to FIGS. 8C and 8D.

The user of the electronic device 101 may directly connect to the server 500 or the IoT devices 600 even without passing through the gateway 400 in relation to partial functions. Through this, the electronic device 101 may selectively control the IoT device that is selected by the user in the case where privacy protection is needed, or particularly, in order to monitor/supplement the control authority and data access. Further, the user of the electronic device 101 may temporarily prevent the authority to perform remote connection or control from an outside using a separate network or VPN in the case where partial security is needed. Through this, the user of the electronic device 101 can collect an actual data access flow or frequency of paths from the IoT devices 600 to the server 500, and thus can efficiently monitor the IoT devices 600.

FIGS. 8A and 8B are diagrams illustrating screens on which an electronic device operates in a gateway mode as an abnormal state of an external device (e.g., gateway) is sensed, according to an embodiment of the present disclosure.

Referring to FIG. 8A, the processor 120 may display an icon 801 related to an IoT device in a living room, an icon 803 related to a door lock IoT device, an icon 805 related to an IoT device in a kitchen, an icon 807 related to an illumination IoT device, an icon 809 related to an IoT device in a bedroom, and an icon 811 related to a motion IoT device as a UI screen related to execution of an IoT service. The processor 120 may control the operation of the IoT devices related to the icons that are displayed in response to the reception of various interaction inputs from the user.

In response to the sensing of the abnormal state of the gateway 400, the electronic device 101 may display a UI item 813 for inquiring whether to execute the gateway mode through the display 160. The user may select any one of the items 815 and 817 for determining whether to execute the gateway mode through an input means such as touch, and the electronic device 101 may perform a function that corresponds to the user's selection input. For example, in the case of receiving a selection input of the item 815 from the user, the processor 120 may control respective configurations of the electronic device 101 so that the electronic device 101 operates in the gateway mode. Further, when receiving a selection input of the item 817 from the user, the processor 120 may control the electronic device 101 to perform only the function of the electronic device 101 related to the IoT service implementation.

Referring to FIG. 8B, the processor 120 may be connected to communicate with at least one IoT device in response to the reception of the selection input of the item 815 from the user, and may display at least one connected IoT device through the display 160. The electronic device 101 may establish a communication connection with the IoT devices 801 and 803 in accordance with the priority information. The electronic device 101 may be connected to communicate with the IoT device in the living room and the door lock IoT device in accordance with the priority information that is set to preferentially connect to only the IoT device in the living room and the door lock IoT device, and may display the icons 801 and 803 indicating that the electronic device 101 is connected to the corresponding IoT devices. In this case, the electronic device 101 may display a notification window for notifying that the electronic device 101 is connected to the first-order IoT device (e.g., IoT device in the living room) and the second-order IoT device (e.g., door lock IoT device) through the display 160.

FIGS. 8C and 8D are diagrams of a method for an electronic device to control an external device (e.g., IoT device) through function switching execution, according to an embodiment of the present disclosure.

Referring to FIG. 8C, the electronic device 101 may execute a security mode for changing a control/connection mode of a part of devices by the user. The currently displayed icons 805 to 812 may be IoT related icons that are controlled by the gateway 400. In the case of receiving an input for changing the control/connection mode of a part of the devices for a CCTV icon 812 from the user, the electronic device 101 may change the control/connection mode so that a CCTV device that is related to the CCTV icon 812 (as shown in FIG. 8D) is controlled by the second gateway that performs the corresponding function or the electronic device 101 instead of the first gateway.

Referring to FIG. 8D, the connection of the corresponding IoT device that is selected as above can be changed to the electronic device, and the corresponding connection configuration (e.g., terminal 814) may be displayed together. In this case, the contents related to the internal/external control and access may be displayed on the connected electronic device to heighten the supplement function.

FIG. 9 is a flowchart of a method for an electronic device 101 to implement an IoT service as an abnormal state between an external device (e.g., gateway 400) and a server 500 is sensed, according to an embodiment of the present disclosure.

At step 905, the processor 120) may receive the abnormal state between the server 500 and the gateway 400. For example, the processor 120 may control the display 160 to display a UI screen indicating that the abnormal state between the gateway 400 and the server 500 has been sensed or received.

At step 910, the processor 120 may inquire as to whether to make the electronic device 101 operate in the gateway mode. For example, the processor 120 of the electronic device 101 may output an inquiry as to whether to make the electronic device 101 perform the function of the gateway 400 through the display 160 or the audio module 280.

Step 910 may be omitted. For example, the electronic device 101 may activate the gateway mode even without any separate input in response to the reception of a signal for commanding the operation of the gateway mode from the server 500. Further, the electronic device 101 may perform the gateway mode through a predetermined policy. The predetermined policy may include a policy to automatically activate the gateway mode if an operation command signal of the gateway mode is not received for a specific time and a policy to automatically activate the gateway mode without any separate command in a specific time.

The electronic device 101 may determine whether to perform the gateway mode. For example, the processor 120 may determine whether to perform the gateway mode based on a capability that can be supported by the electronic device 101. For example, if a connection request for a device to be connected through ZigBee is received from the server 500, the electronic device 101 may determine whether it can support ZigBee, and if so, the electronic device 101 may determine to perform the gateway function.

Although not illustrated, the electronic device 101 may receive a backup function performance request from at least one of the gateway 400 or the server 500, determine whether it can perform the above-described function, and transmit a response to the performance request to the other electronic device or the electronic device that corresponds to the external electronic device at least based on the determination.

At step 915, based on the determination that makes the processor 120 operate in the gateway mode (e.g., if an input for operating in the gateway mode is received through the display 160 or the audio module 280 or based on the predetermined policy), the processor 120 may acquire authority information related to the function performance of the gateway 400 from the processor 501. The detailed operation related to the authority information acquisition may correspond to the operation 715 of FIG. 7. If the electronic device 101 does not operate in the gateway mode, it may proceed to step 655 of FIG. 6 to receive a selection input on whether to end the IoT service from the user.

At step 920, the processor 120 may receive situation information that corresponds to all IoT devices that are managed by the gateway 400 from the gateway 400. Unlike FIG. 7, since the gateway 400 operates normally and only the communication connection between the gateway 400 and the server 500 is unstable or released, the electronic device 101 may receive the situation information that corresponds to the IoT devices 600 from the gateway 400. For example, the processor 120 may receive the situation information that corresponds to at least one of the IoT devices 600 from the gateway 400 through the communication interface 170. Although not illustrated in the FIGs., the electronic device 101 may receive resource information from the gateway 400 or the server 500.

At step 925, the processor 120 may determine whether predetermined priority information exists. Further, if the predetermined priority information does not exist, the electronic device 101, at step 930, may determine whether a priority setting input is received from the user. The detailed operation related to the operations 925 and 930 correspond to steps 725 and 730 of FIG. 7.

If the predetermined priority information exists, the processor 120, at step 940, may select at least one of the IoT devices 600 based on at least one of the predetermined priority information and the situation information that corresponds to the IoT device. For example, the processor 120 may confirm identification information of an IoT device, network state information, communication type information, and operation information. Further, the processor 120 may select at least one of the confirmed IoT devices in accordance with the predetermined priority information.

If the priority setting input is received from the user, the electronic device 101, at step 945, may select at least one IoT device based on at least one of the input priority setting information and the situation information that corresponds to the IoT device. For example, the processor 120 may confirm a connectable IoT device, identification information of the corresponding IoT device, network state information, communication type information, and operation information based on the situation information that corresponds to the IoT device. Further, the processor 120 may select at least one of the confirmed IoT devices in accordance with the priority setting information that is input from the user.

If the priority setting input is not received from the user, the electronic device 101, at step 935, may select at least one IoT device based on only the situation information. For example, the processor 120 may select devices that are currently connectable to the electronic device 101 based on the situation information.

At step 950, the electronic device 101 may provide the situation information that corresponds to the selected IoT device to the server 500. For example, the processor 120 may transmit the situation information, which corresponds to the IoT device that is selected during at least one of steps 935, 940, and 945, among the situation information corresponding to the IoT devices received from the gateway 400 to the server 500.

The processor 120 may transmit a signal for storing or updating the situation information that corresponds to the IoT device in the memory 530 of the server 500 to the server 500. Through this, the electronic device 101 may update the situation information that corresponds to the IoT device and is stored in the server 500.

The processor 120 may update the situation information that corresponds to the corresponding IoT device and was previously stored in the memory 130 with the situation information that corresponds to at least one IoT device and is received from the corresponding IoT device. Through this, the electronic device 101 may update the situation information that corresponds to the IoT device and was stored in the memory 130.

Unlike FIG. 7, since the gateway 400 operates normally and only the communication connection between the gateway 400 and the server 500 is unstable or released, the electronic device 101 may transmit the situation information that corresponds to the IoT devices 600 to the server 500 through supplement of the gateway 400. In this case, the gateway 400 may transmit the situation information that corresponds to at least one IoT device and is received from the IoT device that is connected to the gateway 400 to the electronic device 101 in real time or periodically. However, the present disclosure is not limited thereto, and the electronic device 101 may connect to at least one IoT device simultaneously with or in place of the gateway 400 and may receive the situation information that corresponds to the at least one connected IoT device from the corresponding IoT device.

Further, the electronic device 101 may update the server 500 or the memory 130 of the electronic device 101 using the received situation information.

Although not illustrated, the electronic device 101 may select the IoT device in consideration of not only the priority information and the situation information that corresponds to the IoT but also log information of the IoT device that is included in the situation information. For example, the processor 120 may select the IoT device based on at least one of predetermined priority information, situation information that corresponds to the IoT device, and log information of the IoT device.

Further, the processor 120 may select the IoT device based on at least one of input setting information, the situation information that corresponds to the IoT device, and the log information of the IoT device included in the situation information.

At step 955, the electronic device 101 may determine whether a normal state between the server 500 and the gateway 400 is sensed. For example, the electronic device 101 may sense whether a network connection is performed again in the normal state while executing the gateway mode in accordance with the abnormal network connection state. The normal network state may be defined as a state where signal transmission/reception between the gateway 400 and the server 500 becomes possible.

The electronic device 101 may sense whether the gateway 400 operates in the normal state based on the information that is received from the server 500. For example, if the information (e.g., situation information that corresponds to the IoT device) related to the function performance of the gateway 400, of which the reception from the gateway 400 was interrupted, is re-received, the server 500 may determine that the gateway 400 has been switched to the normal state, and may transmit such determination information to the electronic device 101. The electronic device 101 may directly determine that the gateway 400 has been switched to the normal state through reception of the information related to the function performance of the gateway 400 via the server 500. In addition, the electronic device 101 may determine that the gateway 400 has been switched to the normal state through reception of the information indicating that the gateway 400 and the server 500 are connected to transmit/receive the information during the communication connection with the gateway 400.

If the normal state of the gateway 400 is sensed, the processor 120, at step 960, may remove or return the authority information related to the function performance of the gateway 400 to the server 500. The detailed operation related to step 960 may correspond to step 760 of FIG. 7.

If the normal state of the gateway 400 is not sensed, the electronic device 100 may proceed to the step 655 of FIG. 6 to receive the selection input on whether to end the IoT service from the user.

FIG. 10A is a flowchart of a method for an electronic device to implement an IoT service when a network abnormal state between an external device (e.g., gateway) and a server is sensed, according to an embodiment of the present disclosure.

At step 1005, the processor 120 may receive the abnormal state between the server 500 and the gateway 400. Further, at step 1010, the processor 120 of the electronic device 500 may inquire whether the electronic device 101 operates to perform a function related to the abnormal state. If the electronic device 101 does not operate in the gateway mode, the electronic device 101 may proceed to step 655 of FIG. 6 to receive the selection input on whether to end the IoT service from the user.

The electronic device 101 may determine whether to perform the gateway mode. For example, the processor 120 may determine whether to perform the gateway mode based on capability that is supported by the electronic device 101.

If the electronic device 101 operates in the gateway mode, the processor 120, at step 1015, may acquire authority information related to the function performance of the gateway 400 from the server 500. Steps 1005, 1010, and 1015 may respectively correspond to steps 905, 910, and 915 of FIG. 9.

At step 1020, the processor 120 may receive the situation information that corresponds to at least one IoT device that is selected in accordance with the priority from the gateway 400. Unlike step 920 of FIG. 9, the electronic device 101 may receive situation information that corresponds to the IoT device that is filtered in accordance with the priority policy in the gateway 400.

At step 1025, the processor 120 may transmit the received situation information that corresponds to the IoT devices to the server 500. For example, the processor 120 may transmit the situation information that corresponds to the IoT device and is received from the gateway 400 to the server 500 through the communication interface.

At step 1030, the processor 120 may determine whether a normal network connection state between the server 500 and the gateway 400 is sensed. If the normal network connection state between the server 500 and the gateway 400 is sensed, the electronic device 101, at step 1035, may remove or return the authority information related to the function performance of the gateway 400 to the server 500. If the normal network connection state between the server 500 and the gateway 400 is not sensed, the electronic device 101 may proceed to step 655 of FIG. 6 to receive the selection input on whether to end the IoT service from the user. Steps 1030 and 1035 may respectively correspond to steps 955 and 960 of FIG. 9.

FIG. 10B is a flowchart of a method for an electronic device to implement an IoT service depending on whether a gateway stands alone, according to an embodiment of the present disclosure.

At step 1040, for example, the processor 120 may sense or receive the abnormal state of the server 500. Further, at step 1045, the processor 120 may determine whether the gateway 400 stands alone. For example, the electronic device 101 may confirm whether the gateway 400 operates in a standalone mode. The standalone mode may mean a mode in which the gateway 400 performs an IoT service related function without separate information providing from the server to cope with a case where the gateway 400 is not connected to the server 500 or is unable to receive the service from the server 500. When the gateway 400 operates in a standalone mode, the electronic device 101 may proceed to step 655 of FIG. 6 to receive the selection input on whether to end the IoT service from the user.

Although not illustrated, if the gateway 400 does not operate, although it can stand alone based on the reception of the abnormal state of the server 500, the electronic device 101 may transmit a signal for controlling the gateway 400 to stand alone to the gateway 400.

If the gateway 400 does not stand alone, the processor 120, at step 1050, may acquire the authority information related to the function performance from the gateway 400. The electronic device 101 may acquire the authority information related to the function performance of the gateway 400 from the gateway 400. Further, at step 1055, the processor 120 may receive the situation information that corresponds to the IoT device from the gateway 400. Steps 1050 and 1055 may respectively correspond to steps 715 and 720 of FIG. 7, except the authority information and the situation information that corresponds to the IoT device are received from the gateway 400.

At step 1060, the processor 120 may confirm whether the IoT devices 600 or the gateway 400 attempts to connect to the server 500. If the IoT devices 600 or the gateway 400 attempts to connect to the server 500, at step 1065, the processor 120 may transmit a connection attempt interruption command to the IoT devices 600 or the gateway 400. Through this, the IoT devices 600 or the gateway 400 can be prevented from unnecessarily attempting to connect to the server 500 although the abnormal state of the server 500 is confirmed.

If the IoT devices 600 or the gateway 400 does not attempt to connect to the server 500, the processor 120, at step 1070, may select the IoT device based on at least one of the priority information and the situation information that corresponds to the IoT devices 600. Step 1070 may include at least a part of steps 925, 930, 935, 940, 945, and 950 of FIG. 9.

At step 1075, the processor 120 may store the situation information that corresponds to the selected IoT device. For example, the processor 120 of the electronic device 101 may store the situation information that corresponds to the selected IoT device in the memory 130.

At step 1080, the processor 120 may confirm whether the normal state of the server 500 is sensed. For example, the processor 120 may receive information that the server 500 operates in a normal state from the server 500 or the gateway 400. If the normal state of the server 500 is not sensed, the processor 120 may proceed to step 655 of FIG. 6 to receive the selection input on whether to end the IoT service from the user.

If the normal state of the server 500 is sensed, the electronic device 101 may delete or return the authority information that is received from the gateway 400 to the server 500 or the gateway 400. Further, the electronic device 101 may provide the situation information that corresponds to the selected IoT device to the server 500. Through this, the electronic device 101 may store the situation information that corresponds to the IoT device on the abnormal state of the server 500, and then may update the situation information in the server 500 during sensing of the normal state of the server 500.

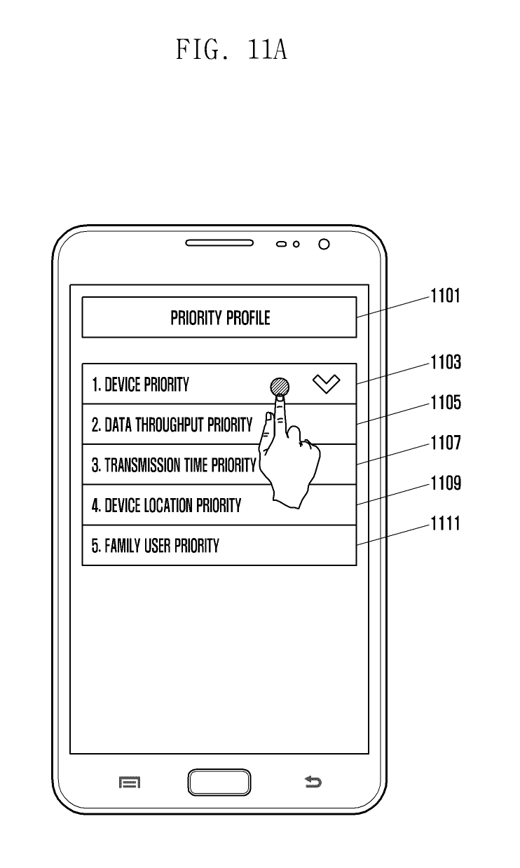

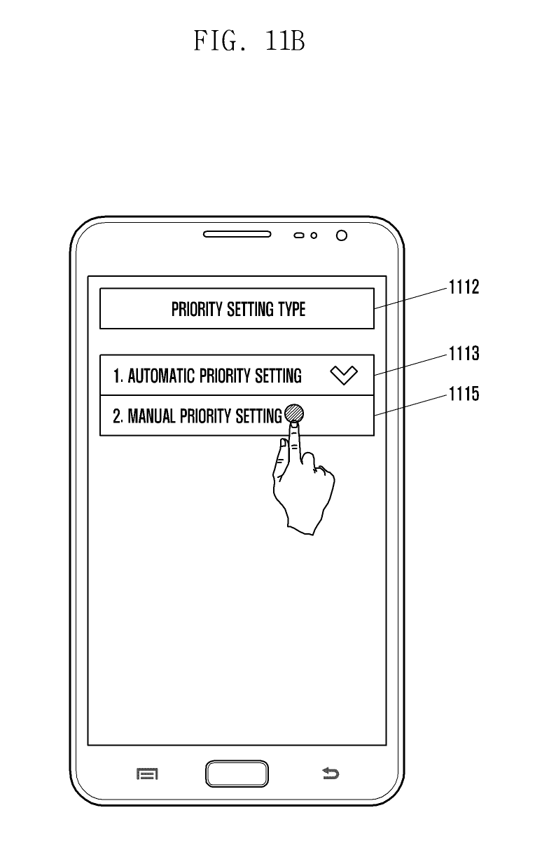

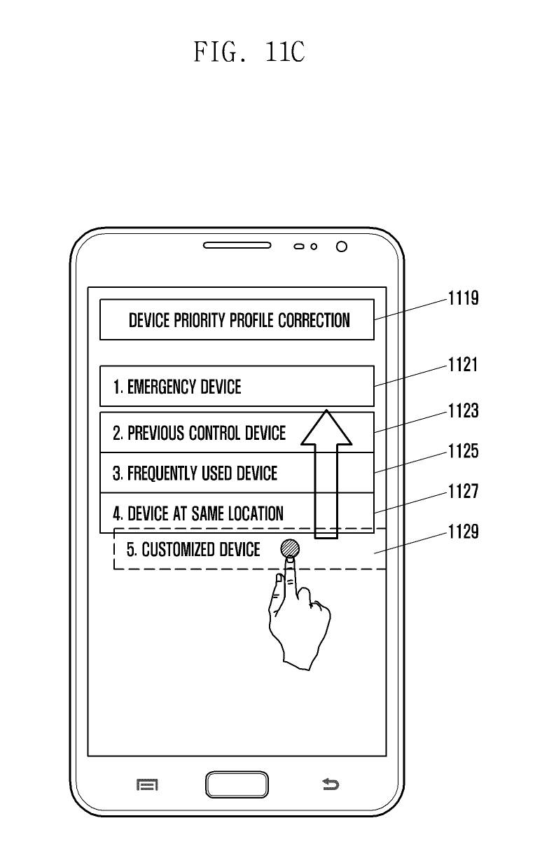

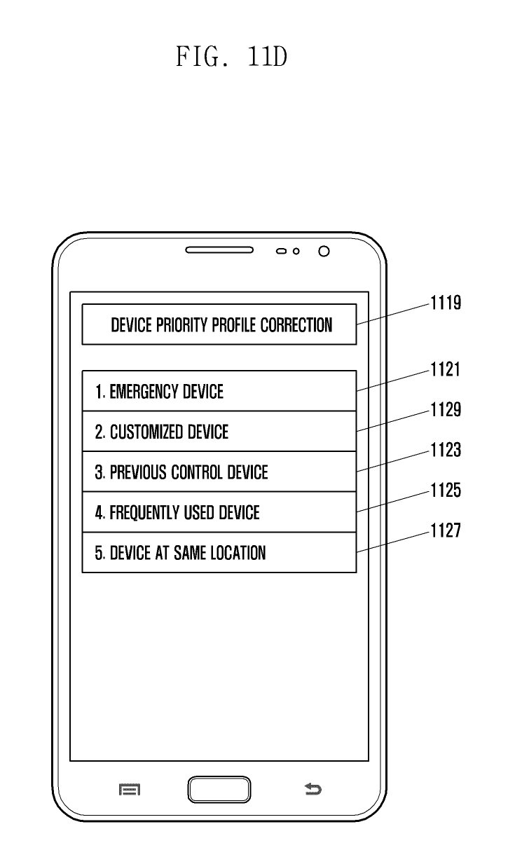

FIGS. 11A to 11D are diagrams illustrating operations for changing setting information of a priority profile 135, according to an embodiment of the present disclosure.

As illustrated in FIG. 11A, the electronic device 101 may output a priority profile menu 1101. The priority profile menu 1101 may be a UI menu capable of setting or changing priority related information that is included in the priority profile 135 in accordance with various user interactions. If the information of the priority profile 135 is changed in accordance with inputs that are made on such a profile menu 1101, the electronic device 101 may store the changed information in the priority profile 135, and may select the IoT device to be controlled based on this through calling of the stored information from the priority profile 135 during the gateway mode activation.

During the calling of the priority profile menu 1101, the electronic device 101 may display a device priority window 1103, a data throughput priority window 1105, a transmission time priority window 1107, a device location priority window 1109, and a family user priority window 1111. As illustrated, the electronic device 101 may also display a check window indicating that the priority profile 135 has been set based on the device priority.

In response to the reception of an input (e.g., touch) for selecting the device priority window 1103 from the user, the electronic device 101 may display a priority setting type menu 1112 as shown in FIG. 11B. The electronic device 101 may automatically or manually set the priority as the priority setting type. For example, the processor 120 may be set to automatically call the priority information in accordance with a predetermined policy when the electronic device 101 refers to the priority profile 135. The predetermined policy may be set when the electronic device 101 is designed or manufactured.

If the priority is set with respect to a device at the same location in accordance with the predetermined policy, the electronic device 101 may preferentially connect to the device at the same location based on the resource information. For example, if the electronic device 101 is in the living room, the IoT devices that are in the living room may be preferentially connected to the electronic device 101.

Further, the processor 120 may be set to call the priority information based on user's setting when the electronic device 101 refers to the priority profile 135. The electronic device 101 may display items 1113 and 1115 capable of selecting the respective setting types through the display 160.

In response to the reception of the selection input (e.g., touch) of the item 1115 from the user, the electronic device 101 may display a screen as shown in FIG. 11C. As illustrated in FIG. 11C, the electronic device 101 may display a device priority profile correction menu 1119. Further, the electronic device 101 may display windows 1121, 1123, 1125, 1127, and 1129 for displaying devices having first to fifth priorities as an example of the device priority. The electronic device 101 may select the IoT device to be controlled based on the currently set priority. For example, referring to the screen of FIG. 11C, the electronic device 101 may set the highest priority with respect to emergency devices. In succession, the electronic device 101 may set the priorities in the order of a previous control device, a frequently used device, a device at the same location, and a customized device.

The priority may be changed as shown in FIG. 11C. For example, the user may touch the customized device window 1129, move the customized device window 1129 onto the previous control device window 1123 through a drag input, and then release the touch.

FIG. 11D illustrates a screen on which the priority is changed by such an operation as described above. As illustrated, the priority may be changed as the customized device window 1129 is displayed on the previous control device window 1123 in accordance with the user's input operation as shown in FIG. 11C.

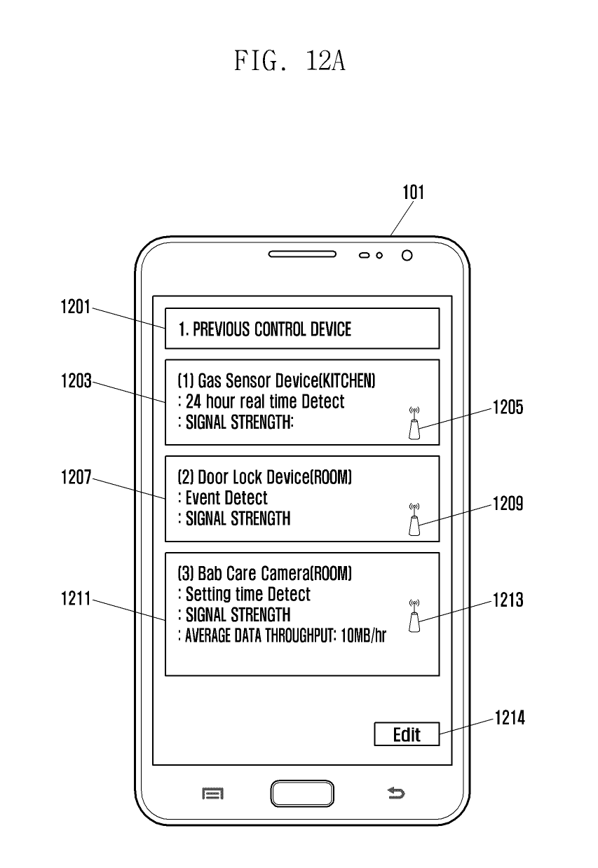

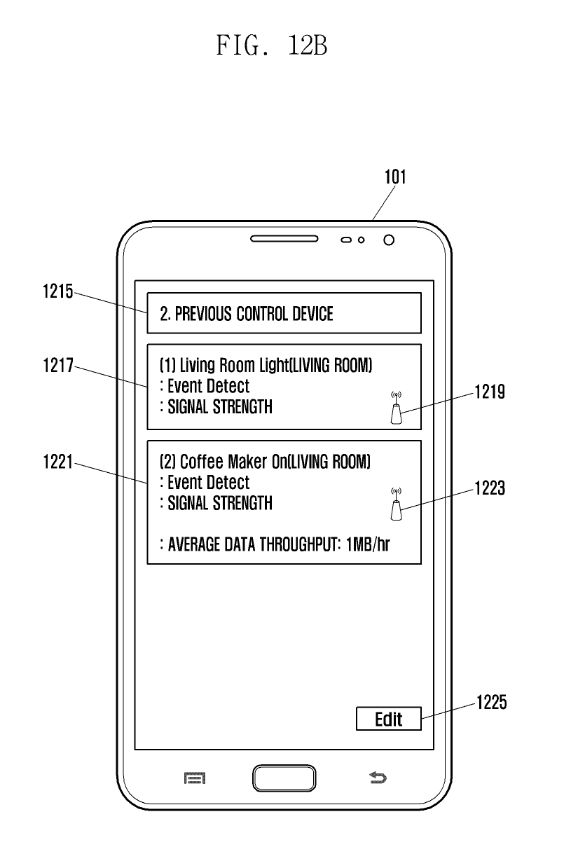

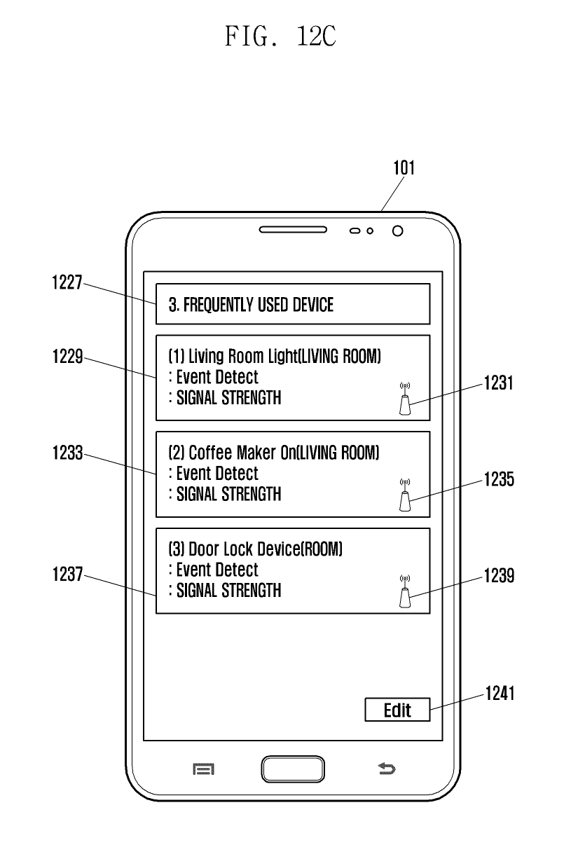

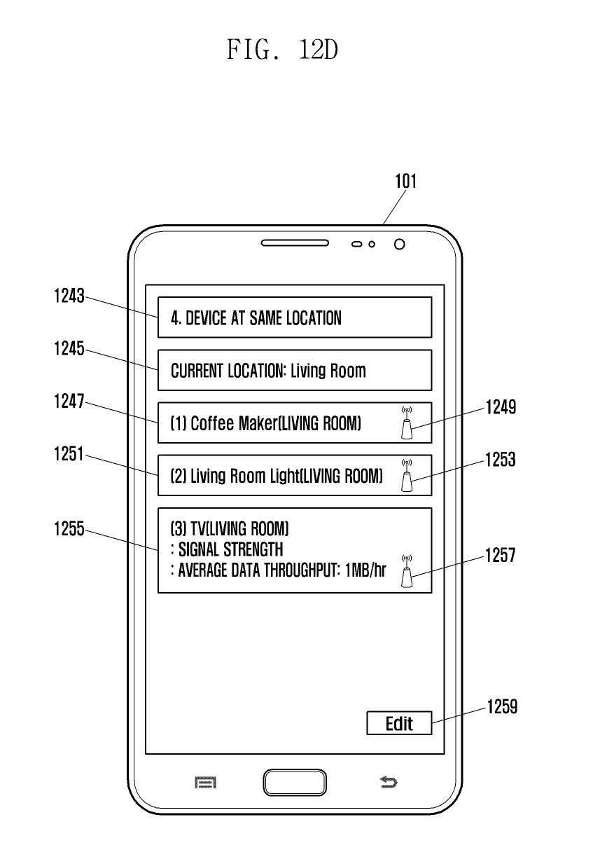

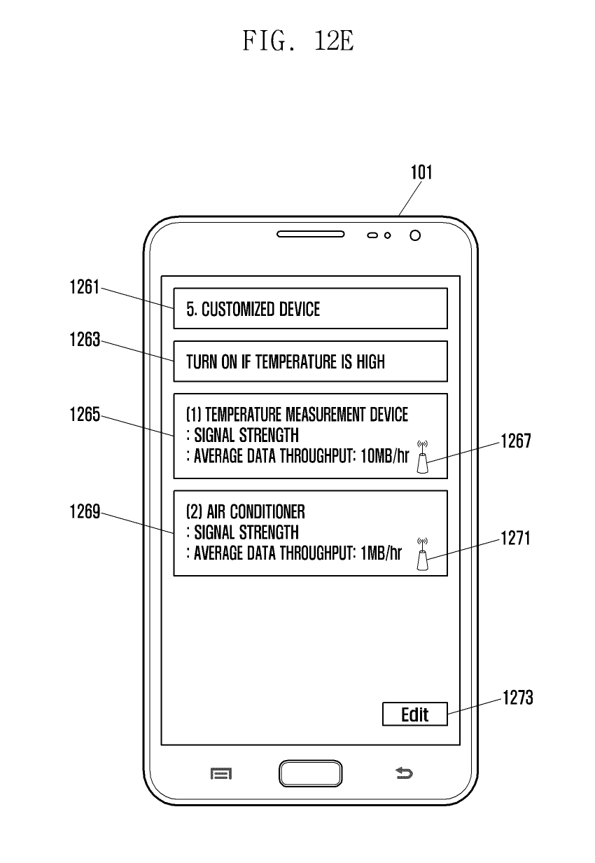

FIGS. 12A to 12E are diagrams illustrating IoT device information corresponding to the kind of priority devices, according to an embodiment of the present disclosure.

Referring to FIG. 12A, IoT devices that correspond to the emergency devices of FIG. 11C are illustrated. For example, if the user clicks the emergency device window 1121 of FIG. 11C, an emergency device menu 1201 and IoT devices that correspond to the emergency devices are illustrated as shown in FIG. 12A. The electronic device 101 may display windows 1203, 1207, and 1211 including information related to corresponding IoT devices and icons 1205, 1209, and 1213 indicating signal strengths of the corresponding IoT devices. Further, the electronic device 101 may display a window 1214 for editing information related to the IoT devices.

Referring to FIG. 12B, IoT devices that correspond to the previous control devices of FIG. 11C are illustrated. For example, if the user clicks the previous control device window 1123 of FIG. 11C, a previous control device menu 1215 and IoT devices that correspond to the previous control devices may be illustrated as shown in FIG. 12B. The electronic device 101 may display windows 1217 and 1221 including information related to the corresponding IoT devices and icons 1219 and 1223 indicating signal strengths of the corresponding IoT devices. Further, the electronic device 101 may display a window 1225 for editing information related to the IoT devices.

Referring to FIG. 12C, IoT devices that correspond to the frequently used devices of FIG. 11C may be illustrated. For example, if the user clicks the frequently used device window 1125 of FIG. 11C, a frequently used device menu 1227 and IoT devices that correspond to the frequently used devices are illustrated as shown in FIG. 12C. The electronic device 101 may display windows 1229, 1233, and 1237 including information related to the corresponding IoT devices and icons 1231, 1235, and 1239 indicating signal strengths of the corresponding IoT devices. Further, the electronic device 101 may display a window 1241 for editing information related to the IoT devices.

Referring to FIG. 12D, IoT devices that correspond to the devices at the same location of FIG. 11C may be illustrated. The devices at the same location may mean devices that are located within a predetermined distance from the electronic device 101. The processor 120 may sense the location of the electronic device 101 and the locations of the IoT devices 600 through various sensors of the electronic device 101 and the communication interface 170.

If the user clicks the same location device window 1127 of FIG. 11C, a same location device menu 1243 and IoT devices that correspond to the same location devices are illustrated as shown in FIG. 12D. The electronic device 101 may display a window 1245 indicating the current location (living room) of the electronic device 101. Further, the electronic device 101 may display windows 1247, 1251, and 1255 including information related to the corresponding IoT devices and icons 1249, 1253, and 1257 indicating signal strengths of the corresponding IoT devices. Further, the electronic device 101 may display a window 1259 for editing information related to the IoT devices.

Referring to FIG. 12E, IoT devices that correspond to the customized devices of FIG. 11C may be illustrated. For example, if the user clicks the customized device window 1129 of FIG. 11C, a customized device menu 1261 and IoT devices that correspond to the customized devices may be illustrated as shown in FIG. 12E. The electronic device 101 may display a window 1263 including the contents of customization. Further, the electronic device 101 may display windows 1265 and 1269 including information related to corresponding IoT devices and icons 1267 and 1271 indicating signal strengths of the corresponding IoT devices. Further, the electronic device 101 may display a window 1273 for editing information related to the IoT devices and customization.

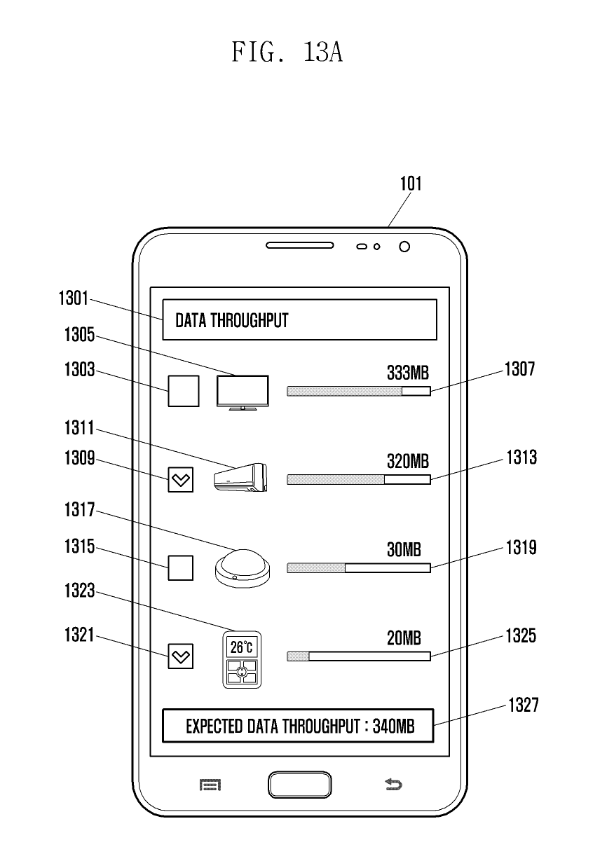

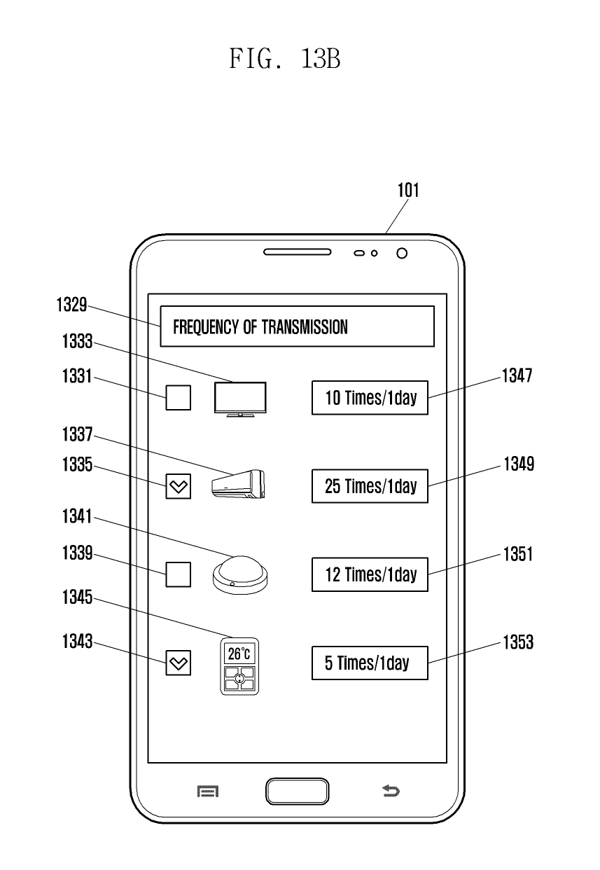

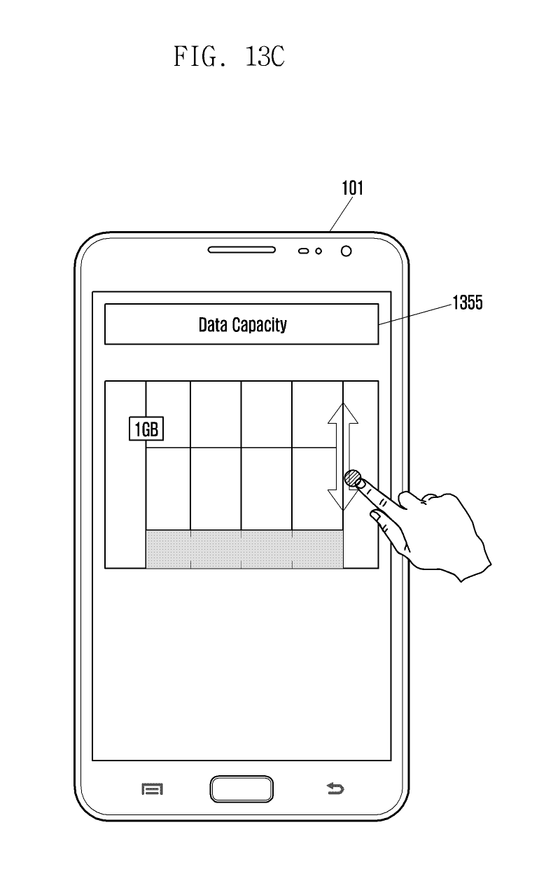

FIGS. 13A to 13C are diagrams illustrating operations for changing setting information of a priority profile 135, according to an embodiment of the present disclosure.

Referring to FIG. 13A, the electronic device 101 may change setting information of the priority profile 135 in accordance with data throughput. The electronic device 101 may output a priority change menu 1301 in accordance with the data throughput to IoT devices. Further, the electronic device 101 may output icons 1305, 1311, 1317, and 1323 related to the IoT devices, icons 1307, 1313, 1319, and 1325 indicating capacity that may be consumed in accordance with data transmission/reception with the corresponding IoT devices, and check boxes 1303, 1309, 1315, and 1321 for selecting whether to connect to the corresponding IoT devices in accordance with the priority.

The electronic device 101 may display the check boxes 1309 and 1321 that can be selected by the user, and may display a window 1327 indicating expected data throughput of the IoT devices that correspond to the selected check boxes 1309 and 1321. The electronic device 101 may update the priority profile 135 based on the IoT devices that are set by the check boxes. Through this, the user may change the setting of the priority profile 135 through intuitively grasping the amount of data that is required during controlling of the corresponding IoT devices.

Referring to FIG. 13B, the electronic device 101 may change setting information of the priority profile 135 in accordance with the number of times of data transmission. The electronic device 101 may display a screen indicating how much situation information that corresponds to the IoT devices is transmitted to the server 500 for a predetermined time. For example, the electronic device 101 may output a priority change menu 1329 in accordance with the frequency of transmission.

The electronic device 101 may output icons 1333, 1337, 1341, and 1343 related to the IoT devices, icons 1347, 1349, 1351, and 1353 indicating how frequently the situation information that corresponds to the corresponding IoT devices is transmitted, and check boxes 1335 and 1343 for selecting whether to connect to the corresponding IoT devices in accordance with the priority. The electronic device 101 may display the check boxes 1335 and 1343 selected by the user, and may update the priority profile 135 based on the IoT devices set by the check boxes. Through this, the user may change the setting of the priority profile 135 through grasping how frequently the corresponding IoT devices are monitored during controlling of the IoT devices.

Referring to FIG. 13C, the electronic device 101 may display a screen for setting the priority in accordance with data capacity that is set by the user. The electronic device 101 may output a menu 1355 through which the setting information of the priority profile 135 can be automatically changed in accordance with the capacity set by the user without specifying the IoT devices one by one by the user in accordance with a user request. The user may set the data capacity to be used to control the IoT devices in accordance with various interactions (e.g., touch and drag), and the electronic device 101 may set the IoT devices to be controlled in accordance with the priority within a range of the data capacity that is set by the user in accordance with a predetermined condition (e.g., referring to another piece of priority information. Through this, the user can change the setting of the priority profile 135 only through setting of the data capacity without selecting the IoT devices one by one by the user.

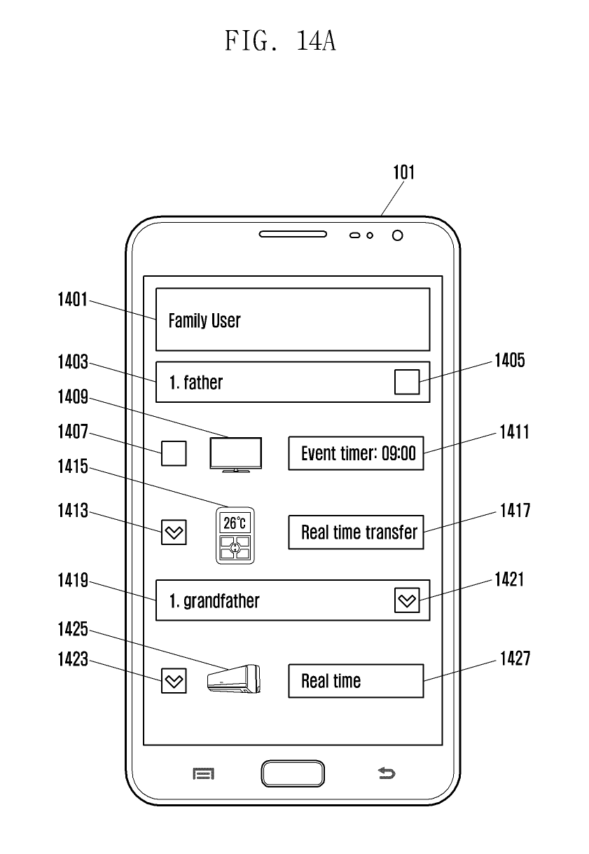

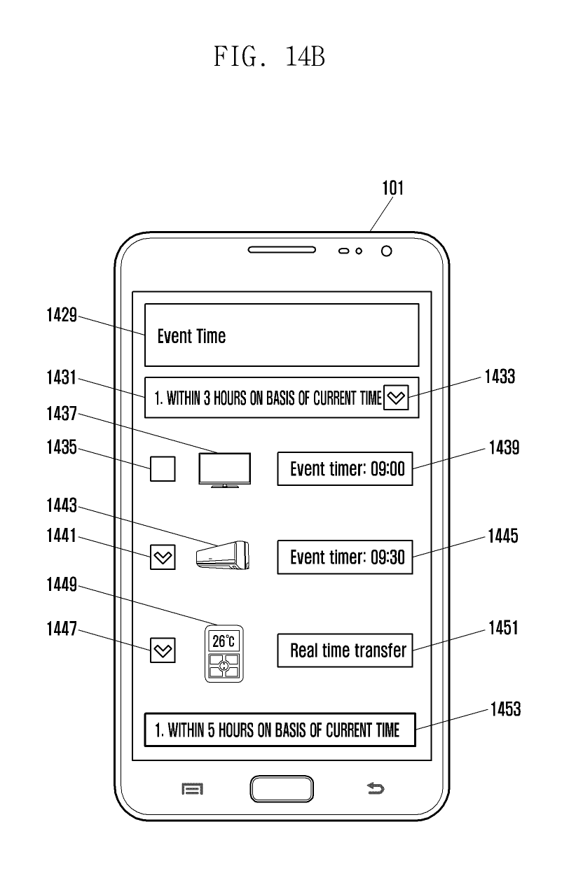

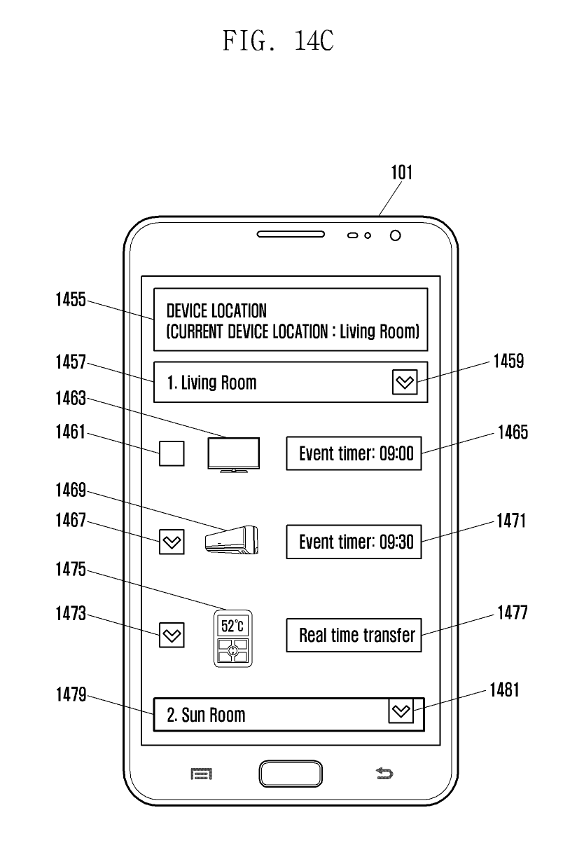

FIGS. 14A to 14C are diagrams illustrating operations for changing setting information of a priority profile 135, according to an embodiment of the present disclosure.

Referring to FIG. 14A, the electronic device 101 may change setting information of the priority profile 135 in accordance with a family user environment. In accordance with a user's request, the electronic device 101 may output an IoT device priority change menu 1401 that is classified in accordance with family members. Further, the electronic device 101 may display windows 1403 and 1419 indicating the family members, IoT device related icons 1409, 1415, and 1425 that are classified in accordance with the family members, items 1411, 1417, and 1427 indicating information related to time when the corresponding IoT devices operate, and check boxes 1405, 1421, 1407, 1413, and 1423 for selecting the family members or IoT devices that are classified in accordance with the family members. The electronic device 101 may update the priority profile 135 based on the IoT devices that are related to the check boxes 1413, 1421, and 1423 selected by the user. Through this, the user may change the setting of the priority profile 135 with reference to the IoT devices (e.g., IoT devices that are frequently used by the corresponding family members) that are classified in accordance with the family members.

Referring to FIG. 14B, the electronic device 101 may change setting information of the priority profile 135 in accordance with the operation time of the IoT devices. In accordance with a user's request, the electronic device 101 may output a priority change menu 1429 related to the IoT device operation time. Further, the electronic device 101 may display windows 1431 and 1453 indicating a predetermined time condition, icons 1437, 1443, and 1449 related to the IoT devices that satisfy the predetermined time condition, items 1439, 1445, and 1451 indicating time when the corresponding IoT devices operate, and check boxes 1435, 1441, and 1447 for selecting the corresponding IoT devices. The electronic device 101 may update the priority profile 135 based on the IoT devices that are related to the selected check boxes 1441 and 1447. Through this, the user may appropriately set the priority profile 135 through confirming a timer time in which the respective IoT devices operate.

Referring to FIG. 14C, the electronic device 101 may change the setting information of the priority profile 135 in accordance with location information of the IoT devices. In accordance with a user's request, the electronic device 101 may display an item 1455 indicating current location information of the electronic device 101 and items 1457 and 1479 indicating representative location information obtained by classifying the locations of the IoT devices. Further, the electronic device 101 may display icons 1463, 1469, and 1475 related to the IoT devices included in the representative location information, items 1465, 1471, and 1477 indicating information related to the operation time of the corresponding IoT devices, and check boxes 1459, 1461, 1467, 1473, and 1481 for selecting the representative location information or the IoT devices that correspond to the representative location information.

The electronic device 101 may update the priority profile 135 based on the IoT devices that are related to the selected check boxes 1459, 1461, 1467, 1473, and 1481. Through this, the user may appropriately change the setting of the priority profile 135 through comparison of the location information of the electronic device 101 with the location information of the IoT devices.

FIGS. 15A to 15D are diagrams illustrating log information of external devices (e.g., IoT devices 600), communication type information, a device profile 133, and a priority profile 135 according to an embodiment of the present disclosure.

Referring to FIG. 15A, log information 1501 of a first IoT device 1503 and a second IoT device 1505 is illustrated. The log information 1501 may include the contents in which the first IoT device 1503 and the second IoT device 1505 communicate with the gateway 400 or the electronic device 101. For example, the log information may include time information and data transmission success/failure information. The log information may be recorded in the server 500 through the gateway 400 or the electronic device 101. The processor 120 may receive the log information of at least one IoT device from the server 500 in real time or periodically. Further, the processor 120 may determine at least one IoT device to be controlled in a gateway mode through setting of the log information as a weight value.

Referring to FIG. 15B, communication type information of the first IoT device 1509, the second IoT device 1511, and the third IoT device 1513 is illustrated. The communication type of the first IoT device 1509 may support BT and Wi-Fi, the communication type of the second IoT device 1511 may support only Wi-Fi, and the communication type of the third IoT device 1513 may support ZigBee. The communication type information is information related to the communication type that is supported by the IoT devices, and may be included in the situation information that corresponds to the IoT devices.

The memory 130 of the electronic device 101 may store the device profile 133 as shown in FIG. 15C. The device profile 133 may be a database in which situation information related to IoT devices, log information related to the IoT devices, and priority information related to the IoT devices are classified and stored by IoT devices. The device profile 133 may include the log information 1501, the communication type information 1507, and the priority profile 135. The device profile 133 may be stored in the memory 130 or may be received from the server 500.

The device profile 133 may further include location information of corresponding IoT devices, user information, and related device information. For example, as illustrated in FIG. 15C, the device profile 133 may include location/user information related to the first IoT device 1517, the second IoT device 1519, and the third IoT device 1521, priority information, related device information, and communication type information.

The memory 130 of the electronic device 101 may store the priority profile 135 as shown in FIG. 15D. According to various embodiments, the priority profile 135 may be a database, and may be stored in the memory 130 or may be received from the server 500. The priority profile 135 may be predetermined by the user or may be input and set by the user during the activation of the gateway mode of the electronic device 101. The processor 120 may refer to the priority profile 135 in order to select or connect to at least one IoT device during the activation of the gateway mode. The priority profile may include priority profiles 1525, 1527, 1529.

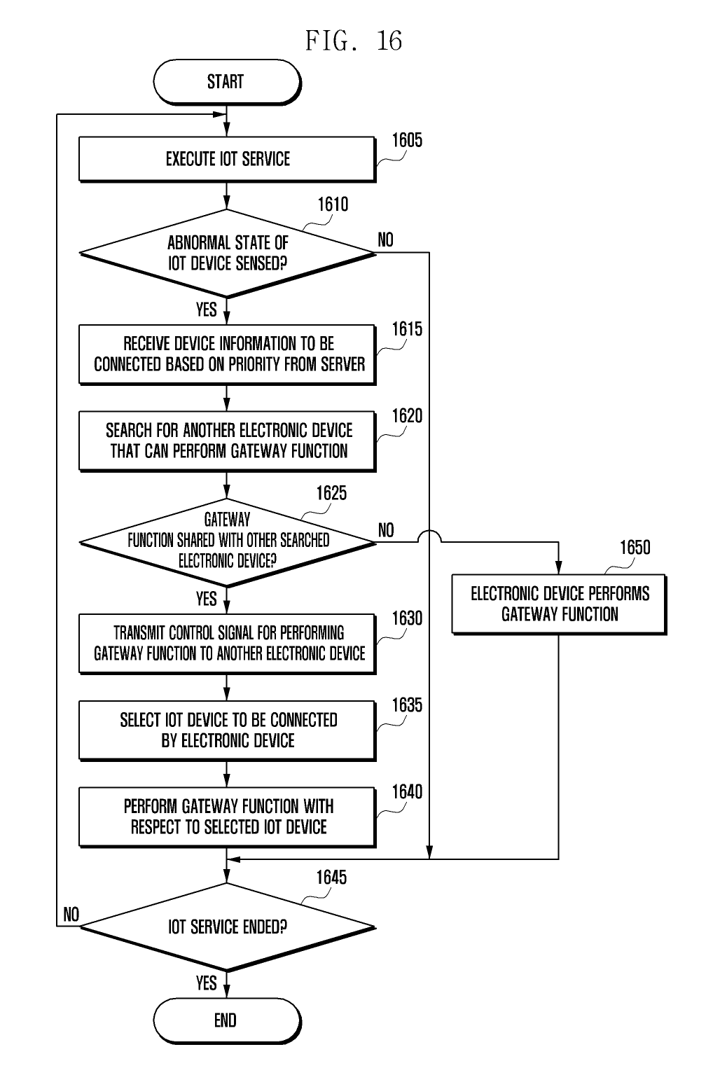

FIG. 16 is a flowchart of a method of for an electronic device 101 to share a function of a gateway 400 with another electronic device, according to an embodiment of the present disclosure.

The electronic device 101 mentioned in FIGS. 16 to 18C and another electronic device may be located within a house of a user of the electronic device 101.

At step 1605, the processor 120 may execute an IoT service. Step 1605 may correspond to the IoT service execution step 605p) of FIG. 6. Further, at step 1610, the electronic device 101 may confirm whether the abnormal state of the IoT service is sensed. If the abnormal state is not sensed, the electronic device 101, at step 1645, may determine whether to end the IoT service.

If the abnormal state of the IoT service is sensed, the electronic device 101, at step 1615, may receive IoT device information to be connected based on the priority from the server 500.

At step 1620, the processor 120 may search for another electronic device, e.g., electronic device 102 and 104, that can perform the function of the gateway 400.

At step 1625, the processor 120 may determine whether to share the gateway function with the other searched electronic device. For example, the processor 120 may inquire whether to activate the gateway mode even in the other searched electronic device. The processor 120 may output such an inquiry to the user through the display 160 or the audio module 280.

If an input for non-sharing the gateway function with the other electronic device is received, the processor 120, at step 1650, may perform the function of the gateway 400. For example, the electronic device 101 may independently operate in the gateway mode.

If an input for sharing the gateway function with the other electronic device is received, the processor 120, at step 1630, may transmit a control signal for performing the function of the gateway 400 to the other electronic device. The processor 120 may transmit a signal for requesting activation of the gateway mode to the other searched electronic device through the communication interface 170.

At step 1635, the processor 120 may select at least one IoT device connected by the electronic device 101. For example, the processor 120 may connect to the electronic device 101 among the IoT devices 600, or may select at least one IoT device to be managed through the electronic device 101.

The processor 120 may share various policies related to the gateway function performance with the other electronic device. For example, the user of the electronic device 101 may negotiate with the user of the other electronic device to bear the gateway function performance. For this, the processor 120 may transmit information related to the selected IoT device to the other electronic device. Further, the processor 120 may transmit a request signal for controlling at least one IoT device except the IoT device selected by the electronic device 101 among the IoT devices 600 to the other electronic device.

The electronic device 101 may perform the gateway function with respect to the selected IoT device. The gateway function performance as described above may include at least one of the above-described operations in FIGS. 6 to 10.

At step 1645, the processor 120 may determine whether to end the IoT service. If the electronic device 101 does not end the IoT service, it may proceed to step 1605 to continuously execute the IoT service, whereas if the electronic device 101 ends the IoT service, it may end the method of FIG. 16.

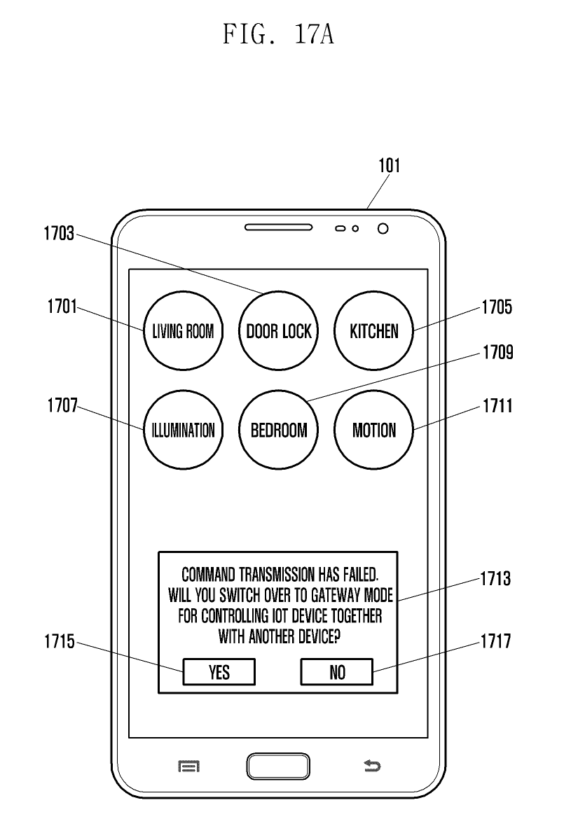

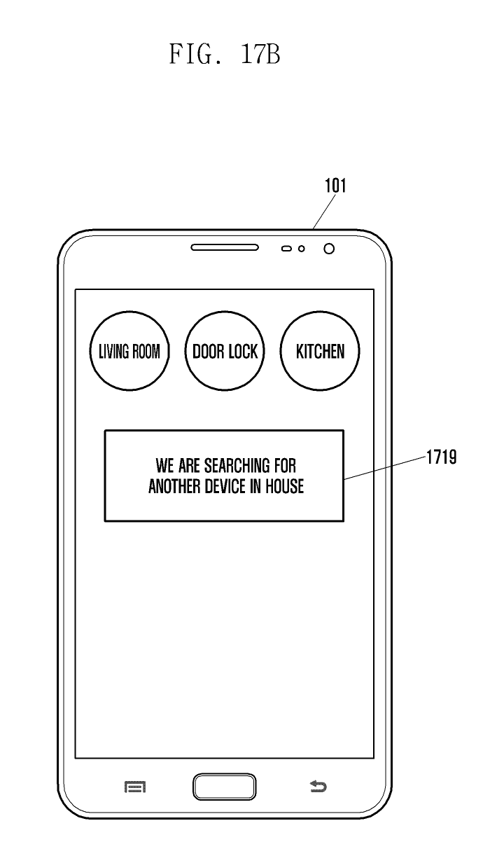

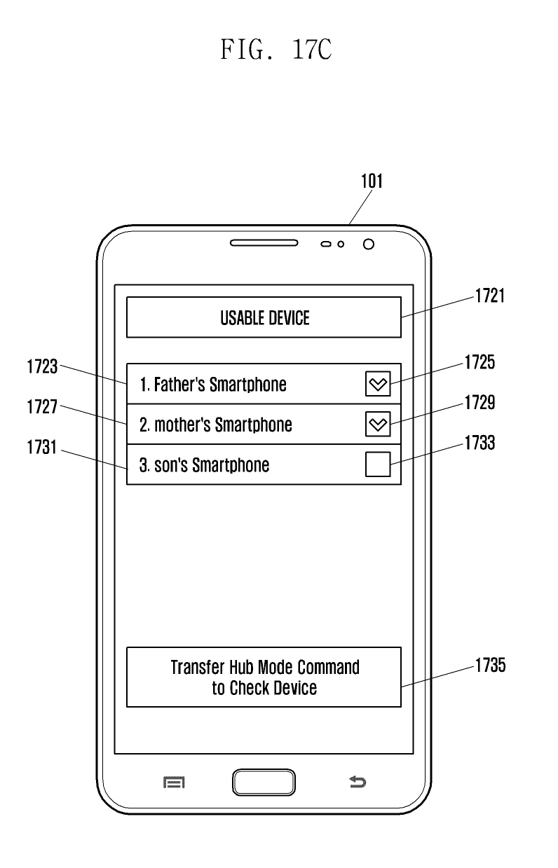

FIGS. 17A to 17C are diagrams illustrating a method for an electronic device 101 to share a function of a gateway 400 with another electronic device, according to an embodiment of the present disclosure.

Referring to FIG. 17A, the electronic device 101 may display an icon 1701 related to an IoT device in a living room, an icon 1707 related to a door lock IoT device, an icon 1703 related to an IoT device in a kitchen, an icon 1709 related to an illumination IoT device, an icon 1705 related to an IoT device in a bedroom, and an icon 1711 related to a motion IoT device as a UI screen related to execution of the IoT service. The processor 120 may control the operation of the IoT devices related to the icons that are displayed in response to the reception of various interaction inputs from the user.

In response to the sensing of the abnormal state of the IoT service, the electronic device 101 may display a UI item 1713 for inquiring whether to switch over to the gateway mode for controlling the IoT device together with another electronic device through the display 160. The user may select any one of the items 1715 and 1717 for determining whether to execute the gateway mode through an input means such as touch, and the electronic device 101 may perform a function that corresponds to the user's selection input. For example, in the case of receiving the selection input of the item 1715 from the user, the processor 120 may control respective configurations of the electronic device 101 so that the electronic device 101 operates in the gateway mode.

Further, the processor 120 may search for another electronic device that is to share the gateway mode. In contrast, in the case of receiving a selection input of the item 1717 from the user, the processor 120 may control the electronic device 101 to perform only the function of the electronic device 101 related to the IoT service implementation. In addition, the processor 120 may control the electronic device 101 so as to independently perform the mode of the gateway 400 without another electronic device.

Referring to FIG. 17B, in the case where the selection input of the item 1715 is received from the user, a screen that is output from the display 160 of the electronic device 101 is illustrated. The electronic device 101 may search for another electronic device that can perform the gateway mode among electronic devices located in the house of the user of the electronic device 101, and may display a screen 1719 for guiding such an operation.

Referring to FIG. 17C, the electronic device 101 may output a usable device menu 1721 in accordance with the search result. The usable devices may be other electronic devices that support the gateway mode, and the electronic device 101 may display items 1723, 1727, and 1731 related to other electronic devices. The electronic device 101 may display check boxes 1725, 1729, and 1733 for selecting the respective electronic devices. If the user selects the items 1723 and 1727 and then select an item 1735 related to the gateway mode request, the electronic device 101 may transmit a gateway mode operation command to other electronic devices (e.g., father's smart phone and mother's smart phone) related to the selected items 1723 and 1727.

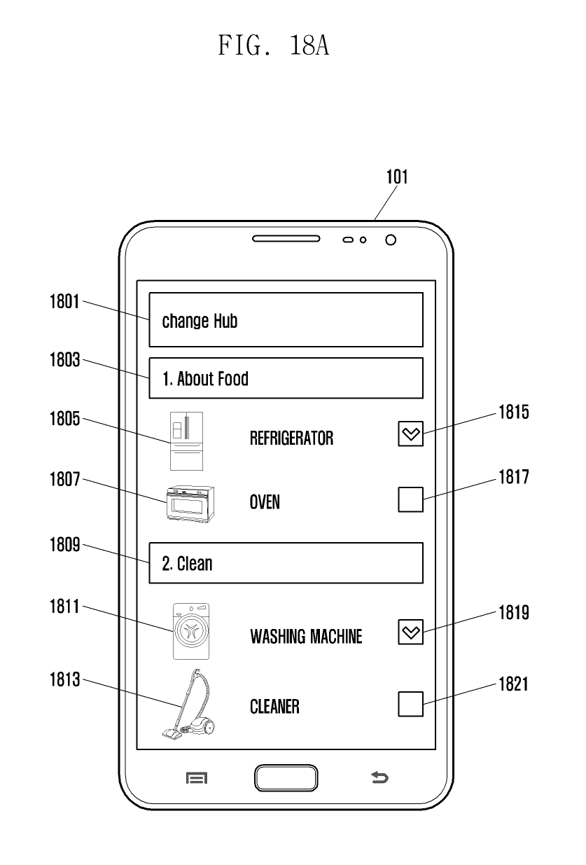

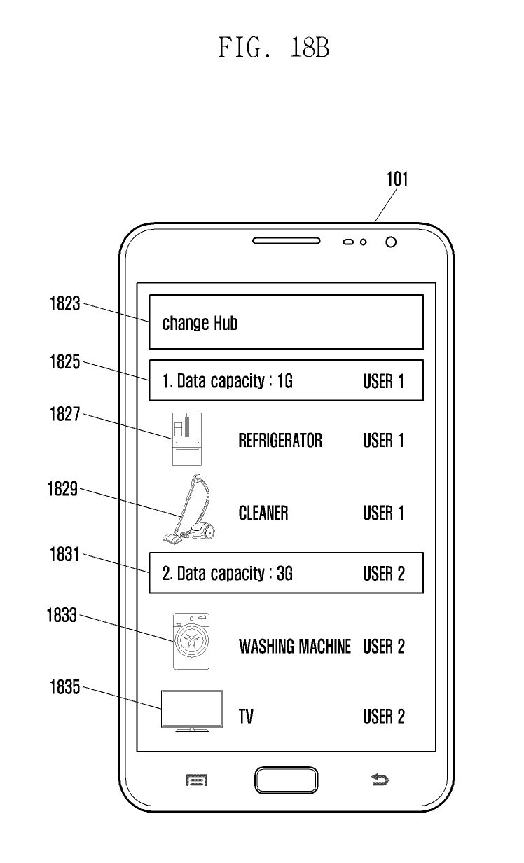

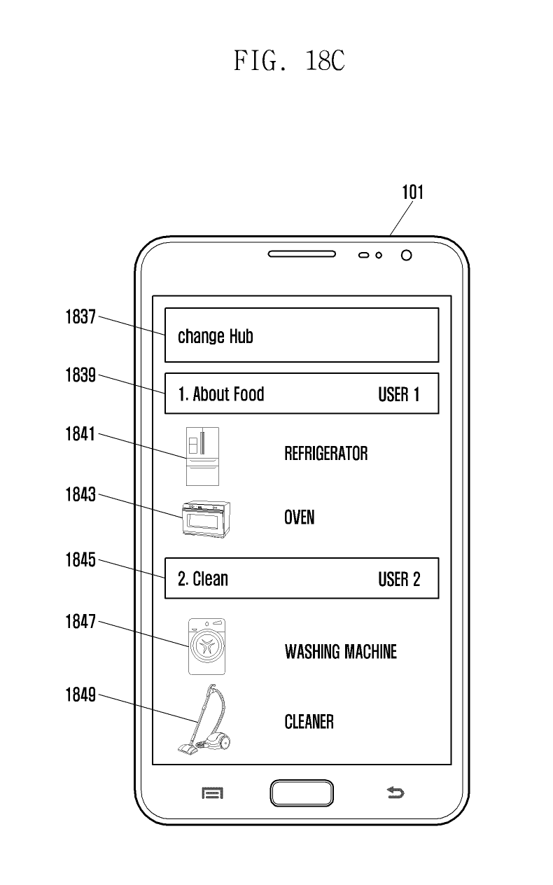

FIGS. 18A to 18C are diagrams of a method for an electronic device 101 to set a gateway function with other electronic devices, according to an embodiment of the present disclosure.

Referring to FIG. 18A, the electronic device may output a menu 1801 for selecting IoT devices classified in accordance with the task characteristic of the IoT devices. The processor 101 may output the menu 1801 in response to an input of a request for sharing the function of the gateway 400 with another electronic device or a request for selecting an IoT device to be connected by the electronic device 101. Further, the electronic device 101 may display items 1803 and 1809 related to the task characteristic of the IoT devices. The items 1803 and 1809 related to the task characteristic of the IoT devices may be, for example, IoT devices related to food or IoT devices related to cleaning.

The electronic device 101 may display items 1805, 1807, 1811, and 1813 related to the corresponding IoT devices and check box items 1815, 1817, 1819, and 1821 for selecting the corresponding IoT devices. If the IoT device is selected by the user, the electronic device 101 may transmit information related to the selected IoT device to another electronic device that shares the function of the gateway 400. The user may negotiate with the user of the other electronic device in relation to the gateway mode function performance through transmission of IoT device information to be connected to the user's electronic device to the other electronic device.

Referring to FIG. 18B, the electronic device 101 may output a screen 1823 for sharing and controlling IoT devices that are classified in accordance with the data throughput with another electronic device. As illustrated, the electronic device may display classification items 1825 and 1831 in accordance with the data throughput, and icons 1827, 1829, 1833, and 1835 related to the IoT devices. The user of the electronic device 101 may be user 1, and the electronic device 101 may transmit/receive data of 1G with the IoT device. Accordingly, a refrigerator IoT device and a cleaner IoT device may be controlled by the electronic device 101, and a washing machine IoT device and a TV IoT device may be controlled by the other electronic device (user 2).

Referring to FIG. 18C, the electronic device 101 may output a screen 1837 for sharing and controlling IoT devices that are classified in accordance with the task characteristic of the IoT devices with another electronic device. As the user selects the refrigerator IoT device and an oven IoT device as shown in FIG. 18A, the processor 120 may display an item 1830 indicating that the electronic device 101 (user 1) takes charge of control of the refrigerator IoT device and the oven IoT device and icons 1841 and 1843. Further, the processor 120 may display an item 1845 indicating that the user (user 2) of another electronic device 101 takes charge of the control of the washing machine IoT device and the cleaner IoT device and icons 1847 and 1849.

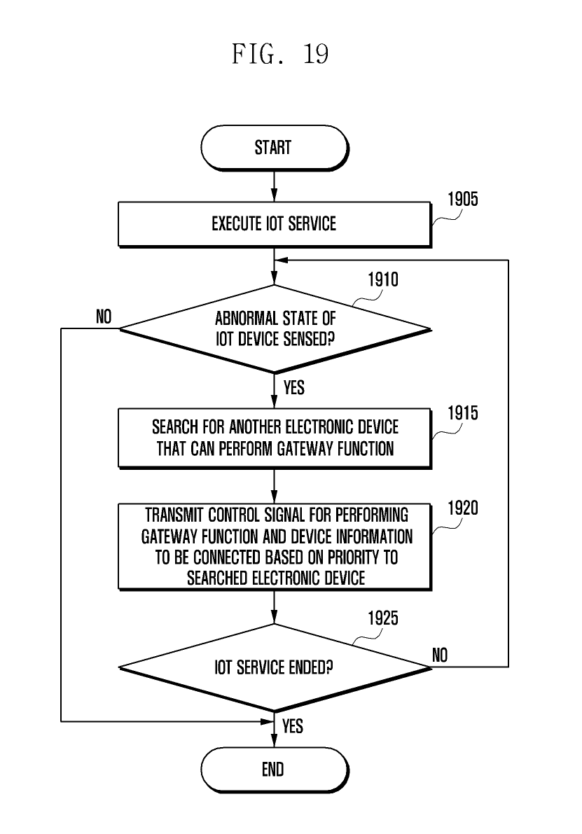

FIG. 19 is a flowchart of a method for an electronic device to request another electronic device to operate in a mode of a gateway 400, according to an embodiment of the present disclosure.

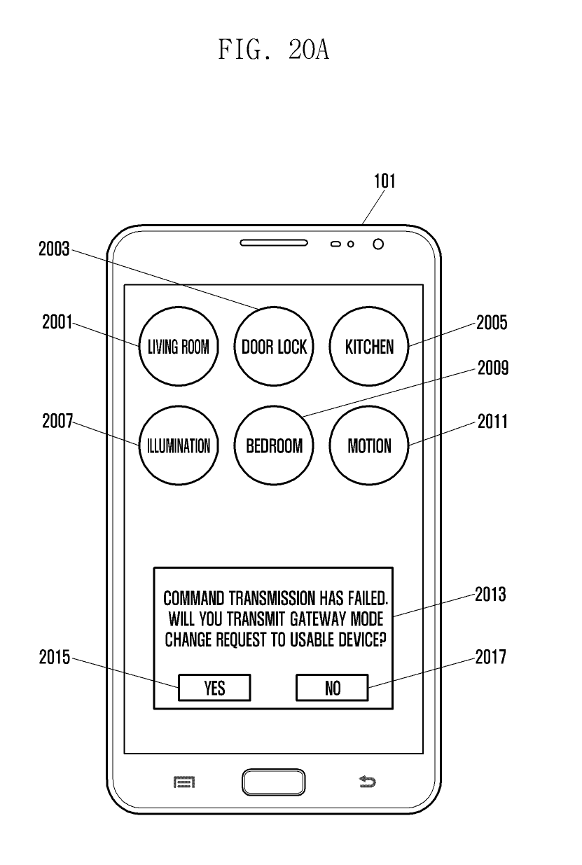

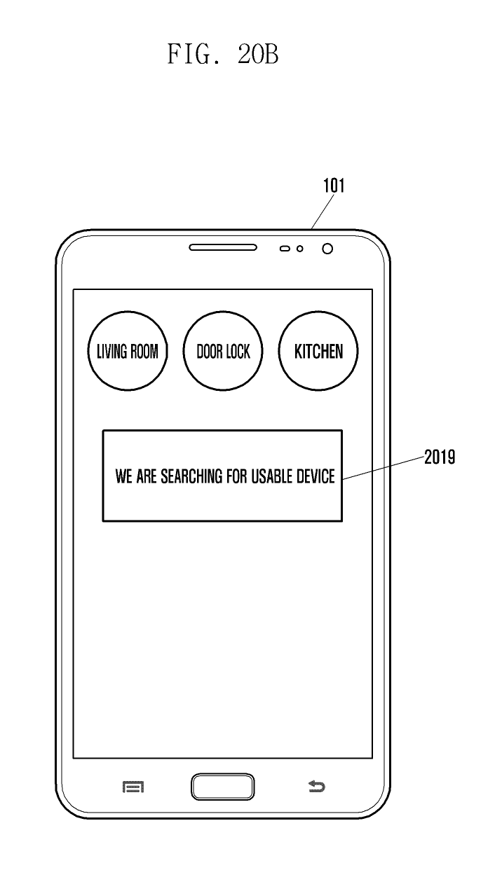

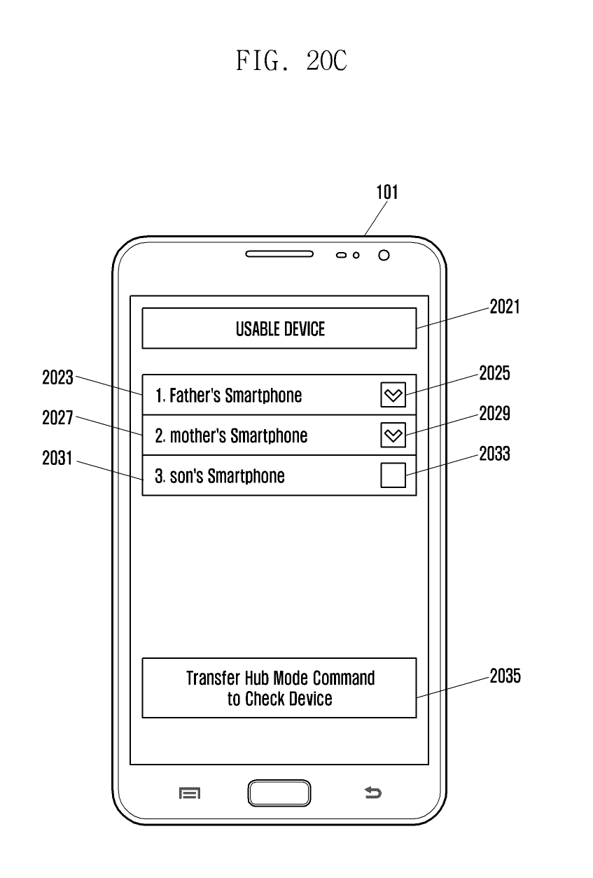

Referring to FIGS. 19 to 20C, the electronic device 101 may be located outside of the user's house, and another electronic device may be located inside of the user's house.

At step 1905, the processor 120 may execute an IoT service. Step 1905 may correspond to the IoT service execution step 1605 of FIG. 16. Further, at step 1910, the processor 120 may determine whether the abnormal state of the IoT service has occurred. If the abnormal state is not sensed, the electronic device 101, at step 1925, may determine whether to end the IoT service.

If the abnormal state of the IoT service is sensed, the electronic device 101, at step 1915, may search for another electronic device that can perform the function of the gateway 400.

At step 1920, the processor 120 may transmit a control signal for performing the function of the gateway 400 and device information to be connected based on the priority to the other searched electronic device.

The processor 120 may receive IoT device information to be connected based on the priority from the server 500, and may transmit the received IoT device information to another electronic device.

At step 1925, the processor 120 may determine whether to end the IoT service. If the IoT service is not ended, the electronic device may proceed to step 1915 to continuously execute the IoT service, whereas if the IoT service is ended, the electronic device may end the method of FIG. 19.

FIGS. 20A to 20C are diagrams illustrating an operation for an electronic device 101 to request another electronic device to operate in a mode of a gateway 400, according to an embodiment of the present disclosure.

Referring to FIG. 20A, the electronic device 101 may display an icon 2001 related to an IoT device in a living room, an icon 2007 related to a door lock IoT device, an icon 2003 related to an IoT device in a kitchen, an icon 2009 related to an illumination IoT device, an icon 2005 related to an IoT device in a bedroom, and an icon 2011 related to a motion IoT device as a UI screen related to execution of the IoT service. The processor 120 may control the operation of the IoT devices related to the icons that are displayed in response to the reception of various interaction inputs from the user.

In response to the sensing of the abnormal state of the IoT service, the electronic device 101 may display a UI item 2013 for inquiring whether to transmit a gateway mode change request to a usable device through the display 160. The user may select any one of the items 2015 and 2017 related to the gateway mode change request through an input means such as touch, and the electronic device 101 may perform a function that corresponds to the user's selection input. For example, in the case of receiving the selection input of the item 2015 from the user, the processor 120 may transmit the gateway mode change request to the usable device. In contrast, in the case of receiving a selection input of an item 2017 from the user, the processor 120 may operate in a standby state.

Referring to FIG. 20B, in the case where the selection input of the item 2015 is received from the user, a screen that is output from the display 160 of the electronic device 101 is illustrated. The electronic device 101 may search for another electronic device that can perform the gateway mode among electronic devices located in the house of the user of the electronic device 101, and may display a screen 2019 for guiding such an operation.

Referring to FIG. 20C, the electronic device 101 may output a usable device menu 2021 in accordance with the search result. The usable devices may be other electronic devices that support the gateway mode, and the electronic device 101 may display items 2023, 2027, and 2031 related to other electronic devices.

Further, the electronic device 101 may display check boxes 2025, 2029, and 2033 for selecting the respective electronic devices. If the user selects the items 2023 and 2027 and then select an item 2035 related to the gateway mode request, the electronic device 101 may transmit a gateway mode operation command to other electronic devices (e.g., father's smart phone and mother's smart phone) related to the selected items 2023 and 2027.

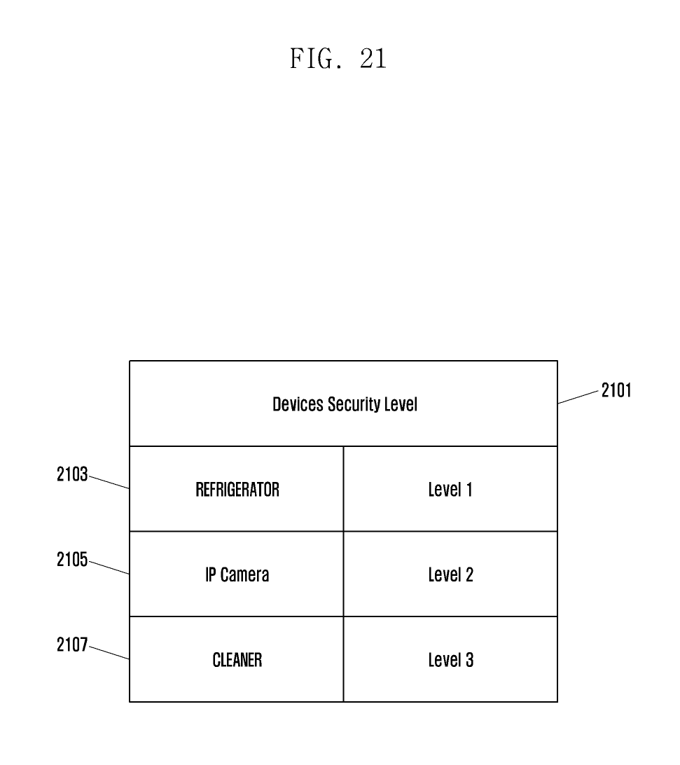

FIG. 21 is a diagram illustrating security policy information of an IoT device, according to an embodiment of the present disclosure.

The electronic device 101 may store a security level of an IoT device as shown in FIG. 21 in the memory 130. As illustrated, security level information (level 1, level 2, and level 3) may be allocated to IoT devices 2103, 2105, and 2107.

The electronic device may receive security level information of the electronic device 101 and security level information of IoT devices from the server 500. The electronic device 101 may confirm the security level information of the IoT device to be connected during activation of the gateway mode. If the confirmed security level information of the IoT device is equal to or lower than the security level information of the electronic device 101, the electronic device 101 may connect to the confirmed IoT device.

If the confirmed security level information of the IoT device is higher than the security level information of the electronic device 101, the processor 120 may perform an additional authentication confirmation procedure. For example, the processor 120 may additionally receive an input of identification information related to the user of the electronic device 101, and may determine whether the input information coincides with information pre-stored in the memory 130. If the input information coincides with the pre-stored information, the processor 120 may connect to the corresponding IoT device.

The electronic device 101 may efficiently control the IoT devices in the gateway mode through setting of the security level information related to the IoT devices as described above.

A method for implementing a service of an electronic device includes, in the electronic device including a memory configured to store resource information of a plurality of external devices including a first external device and a second external device that are connected through at least one short-range wireless communication, a communication module, and a processor, sensing an abnormal state related to the first external device; determining the second external device as a backup device against the abnormal state based on at least the resource information using the processor; and transmitting a request for supplementing a function of the first external device related to the abnormal state to the second external device using the communication module.

The at least one short-range wireless communication of the electronic device may include a first short-range wireless communication and a second short-range wireless communication, and the first short-range wireless communication may include one of ZigBee, Wi-Fi, and Bluetooth, and the second short-range wireless communication may include another of the ZigBee, Wi-Fi, and Bluetooth.

The backup device may be determined by the electronic device at least based on a priority.

The determining by the electronic device may include based on a first priority related to a security service and a second priority related to a previous control device, determining a device that can communicate with the device related to the first priority among the plurality of external devices to connect to the device related to the first priority as the backup device.

The determining by the electronic device may include changing the priority in accordance with situation information that corresponds to the external device.

The changing may include determining an electronic device having a smallest power amount that is consumed for a predetermined time as the backup device.

The determining may include determining the second external device and a third external device among the plurality of external devices as candidate devices for backing up the first external device; transmitting an inquiry on whether it is possible to back up a function related to the abnormal state of the first external device to the second external device and the third external device; and determining the backup device at least based on a response to the inquiry that is received from the second external device or the third external device.

The transmitting may include transmitting at least a part of authority information that is related to the plurality of external devices or at least a part of the resource information to the second external device.

The method may further include transmitting a request for connecting at least one of the plurality of external devices to the second external device to the second external device based on a priority.

A method for implementing a service of an electronic device includes, in the electronic device including a memory, a communication module, and a processor, receiving a request for performing a backup function for another electronic device of which an abnormal state is sensed among a plurality of external devices including the electronic device, which are connected through at least one short-range wireless communication, from the other electronic device or an external electronic device; receiving resource information or authority information for at least parts of the plurality of electronic devices from the other electronic device or the external electronic device using the communication module based on at least the reception; and performing a function related to the abnormal state of the other electronic device based on at least the resource information or the authority information.

The other electronic device may include a gateway, and the external electronic device may include a server.

The performing may include determining whether the electronic device can perform the function; and transmitting a response to the performance request to the other electronic device or an electronic device that corresponds to the external electronic device at least based on the determination.

The performing may further include establishing a communication connection with at least one of the plurality of electronic devices excluding the other electronic device at least based on a priority.

The priority may be determined at least based on situation information related to the electronic device or the other electronic device.

The performing may include establishing a communication connection with the first electronic device between the first electronic device and the second electronic device, which are connected to communicate with the other electronic device before the sensing of the abnormal state, among the plurality of electronic devices; and refraining from establishing a communication connection with the second electronic device.

The method may further include receiving information that corresponds to the abnormal state from the other electronic device or the external electronic device before the reception of the performance request.

The electronic device(s) described herein can provide a continuous service when the abnormal state of the external device (e.g., gateway or server) is sensed or the abnormal state between the external device (e.g., gateway) and the server is sensed.

At least part of the method (e.g., operations) or devices (e.g., modules or functions) may be implemented with instructions that can be conducted via various types of computers and stored in a non-transitory computer-readable storage media, as types of programming modules, for example. One or more processors (e.g., the processor 120) can execute command instructions, thereby performing the functions. An example of the non-transitory computer-readable storage media may be memory 130.

Examples of non-transitory computer-readable media include: magnetic media, such as hard disks, floppy disks, and magnetic media (e.g., magnetic tape); optical media such as CD-ROM disks and DVD; magneto-optical media, such as floptical disks; and hardware devices such as ROM, RAM, flash memory, etc. Examples of program instructions include machine code instructions created by ssembly languages, such as a compiler, and code instructions created by a high-level programming language executable in computers using an interpreter, etc. The described hardware devices may be configured to act as one or more software modules to perform the operations of various embodiments described above, or vice versa.

A non-transitory computer readable storage medium storing commands that are set to cause at least one processor to perform at least one operation when the commands are executed by the at least one processor, wherein the at least one operation may include sensing an abnormal state related to a first external device; determining a second external device as a backup device against an abnormal state based on at least resource information using the processor; and transmitting a request for supplementing a function of the first external device related to the abnormal state to the second external device using a communication module.

A non-transitory computer readable storage medium storing commands that are set to cause at least one processor to perform at least one operation when the commands are executed by the at least one processor, wherein the at least one operation may include, in an electronic device including a memory, a communication module, and a processor, receiving a request for performing a backup function for another electronic device of which an abnormal state is sensed among a plurality of external devices including the electronic device, which are connected through at least one short-range wireless communication, from the other electronic device or an external electronic device; receiving resource information or authority information for at least parts of the plurality of electronic devices from the other electronic device or the external electronic device using the communication module based on at least the reception; and performing a function related to the abnormal state of the other electronic device based on at least the resource information or the authority information.

Modules or programming modules described herein may include one or more components, remove part of them described above, or further include new components. The operations performed by modules, programming modules, or other components, may be executed in serial, parallel, repetitive or heuristic fashion. Part of the operations can be executed in any other order, skipped, or executed with additional operations.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
a communication module;
a memory configured to store resource information of a plurality of external devices including a first external device and a second external device that are connected through at least one short-range wireless communication; and
a processor that is configured to sense an abnormal state related to the first external device, select the second external device as a backup device when the abnormal state of the first external device is sensed based on at least the resource information, and transmit a request for supplementing a function of the first external device related to the abnormal state to the second external device using the communication module.

2. The electronic device of claim 1, wherein the at least one short-range wireless communication comprises a first short-range wireless communication and a second short-range wireless communication, and
the first short-range wireless communication includes one of ZigBee, wireless fidelity (Wi-Fi), Bluetooth, and z-wave, and the second short-range wireless communication includes one of the ZigBee, Wi-Fi, Bluetooth, and z-wave.

3. The electronic device of claim 1, wherein the resource information comprises one of a device identifier, a device location, priority information, a related device, a communication type, an event time of a device, a device power state, device log information, and a combination thereof.

4. The electronic device of claim 1, wherein the processor is further configured to select the backup device at least based on a priority.

5. The electronic device of claim 4, wherein the processor is further configured to select, based on a first priority for an external device for an emergency service and a second priority for an external device for an illumination service, a device that can communicate with the external device related to the first priority to connect to the external device related to the first priority as the backup device.

6. The electronic device of claim 4, wherein the processor is further configured to change the priority in accordance with situation information that corresponds to one of the first external device and the second external device.

7. The electronic device of claim 6, wherein the processor is further configured to select an electronic device that is supplied with a power by an external power as the backup device.

8. The electronic device of claim 6, wherein the at least one short-range wireless communication comprises a first short-range wireless communication and a second short-range wireless communication, and
during the sensing, the processor is further configured to select a device that supports a short-range wireless communication type that has been used by the first external device as the backup device.

9. The electronic device of claim 1, wherein the processor is further configured to select the second external device and a third external device among the plurality of external devices as candidate devices for backing up the first external device,
to transmit an inquiry as to whether it is possible to back up a function related to the abnormal state of the first external device to the second external device and the third external device, and
to select the backup device at least based on a response to the inquiry that is received from one of the second external device and the third external device.

10. The electronic device of claim 1, wherein the processor is further configured to transmit at least a part of authority information that is related to the plurality of external devices to the second external device.

11. The electronic device of claim 10, wherein the processor is further configured to sense a normal state related to the first external device, and
to transmit a message for requesting deletion of one of the authority information and the resource information to the second external device.

12. The electronic device of claim 1, wherein the processor is further configured to transmit a request, for connecting at least one of the plurality of external devices to the second external device, to the second external device based on a priority.

13. An electronic device comprising:
a communication module; and
a processor that is configured to receive a request for performing a backup function for another electronic device of which an abnormal state is sensed among a plurality of external devices, which are connected through at least one short-range wireless communication, from one of the another electronic device and an external electronic device using the communication module,
to receive one of resource information and authority information from one of the another electronic device and the external electronic device using the communication module based on the reception of one of the resource information and authority information, and
to perform a function related to the abnormal state of the another electronic device based on at least one of the resource information and the authority information.

14. The electronic device of claim 13, wherein the another electronic device includes a gateway, and the external electronic device includes a server.

15. The electronic device of claim 13, wherein the processor is further configured to receive information that corresponds to the abnormal state from one of the another electronic device and the external electronic device before the reception of the request for performing the backup function.

16. The electronic device of claim 13, wherein the processor is further configured to determine whether the electronic device can perform the backup function, and
to transmit a response to the request for performing the backup function to an electronic device that corresponds to one of the another electronic device and the external electronic device at least based on the determination of whether the electronic device can perform the backup function.

17. The electronic device of claim 13, wherein the processor is further configured to establish a communication connection with at least one of the plurality of electronic devices excluding the another electronic device at least based on a priority.

18. The electronic device of claim 17, wherein the processor is further configured to establish the communication connection at least based on situation information related to one of the electronic device and the another electronic device.

19. The electronic device of claim 13, wherein the processor is further configured to establish a communication connection with one of the first electronic device and the second electronic device, which are connected to communicate with the another electronic device before the sensing of the abnormal state, and to refrain from establishing a communication connection with the second electronic device.

20. The electronic device of claim 13, wherein the processor is further configured to perform at least a part of a gateway function for at least one of the plurality of external devices.

21. A method for implementing a service of an electronic device including a memory configured to store resource information of a plurality of external devices including a first external device and a second external device that are connected through at least one short-range wireless communication, a communication module, and a processor, the method comprising:
sensing an abnormal state related to the first external device;
selecting the second external device as a backup device when the abnormal state of the first external device is sensed based on at least the resource information using the processor; and
transmitting a request for supplementing a function of the first external device related to the abnormal state to the second external device using the communication module.

22. The method of claim 21, wherein the at least one short-range wireless communication of the electronic device includes a first short-range wireless communication and a second short-range wireless communication, and
the first short-range wireless communication includes one of ZigBee, wireless-fidelity (Wi-Fi), Bluetooth, and z-wave, and the second short-range wireless communication includes one of the ZigBee, Wi-Fi, Bluetooth, and z-wave.

23. The method of claim 21, wherein the backup device is selected by the electronic device at least based on a priority.

24. The method of claim 21, wherein selecting by the electronic device comprises, based on a first priority related to a security service and a second priority related to a previous control device, selecting a device that can communicate with the device related to the first priority to connect to the device related to the first priority as the backup device.

25. The method of claim 23, wherein selecting by the electronic device comprises changing the priority in accordance with situation information that corresponds to the first external device and the second external device.

26. The method of claim 25, wherein changing the priority comprises selecting an electronic device having a smallest power amount that is consumed for a predetermined time as the backup device.

27. The method of claim 21, wherein selecting the second external device comprises:
selecting the second external device and a third external device among the plurality of external devices as candidate devices for backing up the first external device;
transmitting an inquiry as to whether it is possible to back up a function related to the abnormal state of the first external device to the second external device and the third external device; and
selecting the backup device at least based on a response to the inquiry that is received from one of the second external device and the third external device.

28. The method of claim 21, wherein transmitting the request for supplementing a function of the first external device comprises transmitting one of at least a part of authority information that is related to the plurality of external devices and at least a part of the resource information to the second external device.

29. The method of claim 21, further comprising transmitting a request, for connecting at least one of the plurality of external devices to the second external device, to the second external device based on a priority.

30. A method for implementing a service of an electronic device including a memory, a communication module, and a processor, the method comprising:
receiving a request for performing a backup function for another electronic device of which an abnormal state is sensed among a plurality of external devices including the electronic device, which are connected through at least one short-range wireless communication, from one of the another electronic device and an external electronic device;
receiving one of resource information and authority information from one of the another electronic device and the external electronic device using the communication module based on at least the reception of one of the resource information and authority information; and
performing a function related to the abnormal state of the another electronic device based on at least one of the resource information and the authority information.

31. The method of claim 30, wherein the another electronic device includes a gateway, and the external electronic device includes a server.

32. The method of claim 30, wherein performing the backup function for another electronic device comprises:
determining whether the electronic device can perform the backup function; and
transmitting a response to the request for performing the backup function to one of the another electronic device and an electronic device that corresponds to the external electronic device at least based on the determination of whether the electronic device can perform the backup function.

33. The method of claim 30, wherein performing the backup function further comprises establishing a communication connection with at least one of the plurality of electronic devices excluding the another electronic device at least based on a priority.

34. The method of claim 33, wherein the priority is determined at least based on situation information related to one of the electronic device and the another electronic device.

35. The method of claim 30, wherein performing the backup function comprises:
establishing a communication connection with the first electronic device and the second electronic device, which are connected to communicate with the another electronic device before the sensing of the abnormal state; and
refraining from establishing a communication connection with the second electronic device.

36. The method of claim 30, further comprising receiving information that corresponds to the abnormal state from one of the another electronic device and the external electronic device before the reception of the request for performing the backup function.
